(19) United States
(12) Patent Application Publication
(10) Pub. No.: US 2026/0199828 A1
(43) Pub. Date: Jul. 16, 2026

(54) METHODS FOR CO2 CAPTURE FROM GASES

(71) Applicants: Toyota Motor Engineering & Manufacturing North America, Inc., Plano, TX (US); The Board of Trustees of the University of Illinois, Urbana, IL (US)

(72) Inventors: Kyle C. Smith, Champaign, IL (US); JeongA Lee, Savoy, IL (US); Paul G. Rozzi, Urbana, IL (US); Timothy S. Arthur, Ann Arbor, MI (US); Charles Alexander Roberts, Farmington Hills, MI (US); Vu Quoc Do, Urbana, IL (US)

(73) Assignees: Toyota Motor Engineering & Manufacturing North America, Inc., Plano, TX (US); Toyota Jidosha Kabushiki Kaisha, Toyota-shi Aichi-ken (JP); The Board of Trustees of the University of Illinois, Urbana, IL (US)

(21) Appl. No.: 19/368,311

(22) Filed: Oct. 24, 2025

Related U.S. Application Data
(60) Provisional application No. 63/745,219, filed on Jan. 14, 2025.
(60) Provisional application No. 63/818,335, filed on Jun. 5, 2025.

(51) Int. Cl. B01D 53/32; B01D 53/14

(52) U.S. Cl. CPC B01D 53/326; B01D 53/1412; B01D 53/1475; B01D 2252/10; B01D 2257/504

(57) ABSTRACT

A method for capturing CO₂ includes flowing a CO₂-lean gas into a CO₂ capture side of an electrolytic cell that has the CO₂ capture side, a CO₂ release side, an electrolyte with a CO₂ capture side electrolyte and a CO₂ release side electrolyte, a at least one reversible, current-driven proton or hydroxide source/sink, and at least one reversible, current-driven alkali-cation source/sink. A CO₂ capture cycle includes capturing CO₂ from the CO₂-lean gas via increasing an alkali-cation concentration of the CO₂ capture side electrolyte, and releasing CO₂ from the electrolyte via decreasing an alkali-cation concentration of the CO₂ release side electrolyte such that a CO₂-rich gas is released therefrom.

### CROSS-REFERENCE TO RELATED APPLICATIONS

This application claims priority to U.S. Provisional Application No. 63/745,219 filed on Jan. 14, 2025, and U.S. Provisional Application No. 63/818,335 filed on Jun. 5, 2025, both of which are incorporated herein in their entirety by reference.

### TECHNICAL FIELD

The present disclosure relates generally to the capture of carbon dioxide from gas streams and particularly to capture of carbon dioxide from gas streams using electrochemical devices.

### BACKGROUND

The concentration of carbon dioxide (CO₂) in air is orders-of-magnitude lower (e.g., 400 ppm) than in point-source polluted feeds (e.g., flue gas), and such a low concentration of CO₂ challenges the energy efficiency and economics of using direct-air capture techniques and processes to reduce CO₂ levels in the atmosphere. Currently, the most mature CO₂ capture technology uses liquid amine-based sorbent, though predominantly applied to point-source polluted feeds. However, amines suffer from a high heat cost to regenerate, environmental/safety hazards, and degradation.

The present disclosure addresses issues related to the cost and efficiency of CO₂ capture from air, and other issues related to CO₂ capture.

### SUMMARY

This section provides a general summary of the disclosure and is not a comprehensive disclosure of its full scope or all of its features.

In one form of the present disclosure, a method for capturing CO₂ includes flowing a CO₂-lean gas into an electrolytic cell with a CO₂ capture side and a CO₂ release side. The CO₂ capture side includes a CO₂ capture side electrolyte and the CO₂ release side includes a CO₂ release side electrolyte. The electrolytic cell also includes at least one reversible, current-driven proton or hydroxide source or sink (source/sink), and at least one reversible, current-driven alkali-cation source/sink. The method also includes executing a cycle that includes capturing CO₂ from the CO₂-lean gas via increasing an alkali-cation concentration of the CO₂ capture side electrolyte, releasing CO₂ from the electrolyte via decreasing an alkali-cation concentration of the CO₂ release side electrolyte such that a CO₂-rich gas is released therefrom, and at least one of isobar stepping during capturing the CO₂, isobar stepping during releasing the CO₂, pre-mixing the CO₂ capture side electrolyte with the CO₂ release side electrolyte, and using dissimilar volumes of the CO₂ capture side electrolyte and the CO₂ release side electrolyte.

In another form of the present disclosure, a method for capturing CO₂ includes flowing a CO₂-lean gas into an electrolytic cell with a CO₂ capture side and a CO₂ release side. The CO₂ capture side includes a CO₂ capture side electrolyte and the CO₂ release side includes a CO₂ release side electrolyte. The electrolytic cell also includes at least one reversible, current-driven proton or hydroxide source/sink, and at least one reversible, current-driven alkali-cation source/sink. The method also includes executing a cycle that includes capturing CO₂ from the CO₂-lean gas via increasing an alkali-cation concentration of the CO₂ capture side electrolyte, releasing CO₂ from the electrolyte via decreasing an alkali-cation concentration of the CO₂ release side electrolyte such that a CO₂-rich gas is released therefrom, and isobar stepping during capturing the CO₂ and isobar stepping during releasing the CO₂.

In still another form of the present disclosure, a method for capturing CO₂ includes flowing a CO₂-lean gas into an electrolytic cell that has a CO₂ capture side and a CO₂ release side. The CO₂ capture side includes a CO₂ capture side electrolyte and the CO₂ release side includes a CO₂ release side electrolyte. The electrolytic cell also includes at least one α-K_{0.05}MnO₂ electrode and a cation-exchange membrane. The method also includes executing a cycle of capturing CO₂ from the CO₂-lean gas via increasing an alkali-cation concentration of the CO₂ capture side electrolyte, releasing CO₂ from the electrolyte via decreasing an alkali-cation concentration of the CO₂ release side electrolyte such that a CO₂-rich gas is released therefrom, and pre-mixing the CO₂ capture side electrolyte with the CO₂ release side electrolyte.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A illustrates an electrolytic cell in the form of a Faradaic deionization (FDI) flow cell and an alkaline electrochemical process used to effectively capture and release CO₂ using α-K_{0.05}MnO₂ proton intercalation electrodes according to one form of the present disclosure;

FIG. 1B is a graphical plot showing equilibrium concentration of dissolved inorganic carbon (DIC), K⁺ ions, and Cl⁻ ions as a function of pH at 25° C., where the vertical lines indicate the transition from anion- to cation-compensated systems for the two differential CO₂ partial pressures (400 ppm and 1 bar) shown in the graphical plot;

FIG. 1C is a graphical plot of a thermodynamic cycle diagram for an ideal asynchronous CO₂ capture cycle using alkalization and dealkalization steps in the alkaline pH regime with contours of liquid-phase K⁺ concentration and gas-phase CO₂ partial pressure overlaid based on an equilibrium analysis;

FIG. 2A is a graphical plot of specific capacity versus cycle number for three-electrode, flooded-cell experiments and cycling of α-K_{0.05}MnO₂ electrodes and electrolytic MnO₂ (EMD) electrodes under identical C-rate (2 C, 0.41 mA cm⁻²) and electrolyte;

FIG. 2B is a graphical plot of working electrode voltage versus specific capacity for three-electrode, flooded-cell experiments using α-K_{0.05}MnO₂ electrodes cycled at a C-rate of 2 C (0.56 mA cm⁻²) in a pH≈9.8 electrolyte containing 81 mM DIC and 104 mM K⁺;

FIG. 3A shows a process and instrumentation diagram for an asynchronous electrochemical CO₂ capture apparatus with inlet valves (IVs), outlet valves (Ovs), process-switch valves (PSVs), and mass flow controllers (MFCs), according to the teachings of the present disclosure;

FIG. 3B is a graphical plot showing a representative time sequence with alkalization and dealkalization steps that are driven by the electrochemical cycling of proton-intercalation electrodes at 0.54 mA cm⁻² while no gas flow to bubblers occurs, switching of IVs and outlet valves OVs under open-circuit (OC) conditions to enable the continuous generation of a K⁺ concentration swing before and after switching of electric current, and actuation of PSVs after a predetermined number of electrochemical half-cycles to enable the asynchronous capture and release of CO₂ within bubblers from feed gas flowing at 150 sccm, during which period the electrochemical cell was held under OC conditions;

FIG. 4A is a graphical plot of a predicted thermodynamic cycle diagram for the asynchronous CO₂ capture process according to the teachings of the present disclosure, neglecting inter-stream electrolyte mixing and using a K⁺ concentration swing of 36.1 mM, a mean K⁺ concentration of 107 mM, and assuming electrolyte equilibrium at states 1 and 3 with 400 ppm CO₂ pressure to produce a 24.9 mM DIC concentration swing in the electrolyte;

FIG. 4B is a graphical plot showing experimentally measured CO₂ transferred between electrolyte streams and gaseous feeds during the first three contacting steps (Capture Cyle Number) of an asynchronous CO₂ capture process, and per the cycle shown by FIG. 4A with CO₂ transfer normalized both by the mass of the working electrode (left vertical axis) and by electrolyte volume (right vertical axis);

FIG. 4C is a graphical plot showing specific energy consumed (SEC) and productivity for the latter two capture cycles of the asynchronous process illustrated in FIG. 4A, including contacting steps and their preceding (de)alkalization steps, with error bars including uncertainty propagated from the measurement of CO₂ partial pressure, flow rate, electrode area, voltage, current, and time;

FIG. 5A illustrates inter-stream mixing resulting from imperfect valve timing and hydrodynamic dispersion of solute along flow paths;

FIG. 5B is a graphical plot showing predicted change in K⁺ concentration with half-cycle number for alkalization and dealkalization steps with five ratios of mixing volume Vₘᵢₓ normalized by electrode volume Vₑ, with symbols in the plot showing experimental data obtained using 60 mL reservoir volume, and error bars including uncertainty propagated from aliquot volume and the standard deviation in ion chromatography calibration;

FIG. 5C is a graphical plot showing predicted change in DIC concentration with half-cycle number under the same conditions illustrated in FIG. 5B;

FIG. 5D is a graphical plot showing a predicted thermodynamic cycle diagram, resulting in smaller DIC concentration swing in the presence of inter-stream mixing;

FIG. 5E is a graphical plot showing a predicted efficiency of K⁺ concentration swing and of DIC concentration retention as a function of the ratio of dimensionless electrode capacity Q* to dimensionless mixing volume

$${V}_{mix}^{*} = {V}_{mix} / {V}_{p} ;$$

FIG. 6A is a graphical plot showing predicted thermodynamic cycle diagram for the pre-mixed asynchronous CO₂ capture process according to the teachings of the present disclosure, using a K⁺ concentration swing of 36.1 mM, a mean K⁺ concentration of 107 mM, and assuming electrolyte equilibrium at states 1 and 3 with 400 ppm CO₂ pressure to produce a 12.5 mM DIC concentration swing in the electrolyte;

FIG. 6B is a graphical plot showing experimentally measured CO₂ transferred between electrolyte streams and gaseous feeds during the first three contacting steps of an asynchronous CO₂ capture process, and after the cycle shown in FIG. 6A;

FIG. 6C is a graphical plot showing energy consumed and productivity for the latter two capture cycles of the asynchronous process illustrated in FIG. 6A, including contacting steps and their preceding (de)alkalization steps, with error bars including uncertainty propagated from the measurement of CO₂ partial pressure, flow rate, electrode area, voltage, current, and time;

FIG. 7A is a graphical plot showing contours of CO₂-transfer charge efficiency Λ_{CO}_{₂} as a function of c_{min,K}_{⁺} and Δc_{tot,K}_{⁺} with a release-side CO₂ pressure p_{CO}_{₂}_{,rel}=400 ppm (air);

FIG. 7B is a graphical plot showing contours of CO₂-transfer charge efficiency Λ_{CO}_{₂} as a function of c_{min,K}_{⁺} and Δc_{tot,K}_{⁺} with a release-side CO₂ pressure p_{CO}_{₂}_{,rel}=8000 ppm;

FIG. 7C is a graphical plot showing contours of CO₂-transfer charge efficiency Λ_{CO}_{₂} as a function of c_{min,K}_{⁺} and Δc_{tot,K}_{⁺} with a release-side CO₂ pressure p_{CO}_{₂}_{,rel}=0.03 bar (water vapor pressure at room temperature);

FIG. 7D is a graphical plot showing contours of CO₂-transfer charge efficiency Λ_{CO}_{₂} as a function of c_{min,K}_{⁺} and Δc_{tot,K}_{⁺} with a release-side CO₂ pressure p_{CO}_{₂}_{,rel}=1 bar;

FIG. 7E is a graphical plot showing a comparison of two representative cycles from FIG. 7D with different Λ_{CO}_{₂} values in the plane of c_{DIC} versus of c_{K}_{⁺};

FIG. 7F is a graphical plot showing corresponding cycles in the plane of c_{DIC} versus pH;

FIG. 8 is a series of graphical plots with the top row showing DIC-retained cycles using different release-side pressures and the bottom row showing DIC-retained cycles using pre-mixed cycles and different release-side pressures, and the isobars show solution compositions that are in equilibrium with various gaseous CO₂ concentrations;

FIG. 9 is a graphical plot showing charge efficiency for DIC-retained cycles formed as a function of p_{CO}_{₂}_{,rel}, Δc_{tot,K}_{⁺}, and c_{min,K}_{⁺};

FIG. 10 is a graphical plot showing charge efficiency for DIC-retained cycles formed as a function of p_{CO}_{₂}_{,rel}, Δc_{tot,K}_{⁺}, and c_{min,K}_{⁺} using pre-mixing

FIG. 11 is a graphical plot of specific capacity of α-K_{0.05}MnO₂ electrodes for proton intercalation versus cycle number when using different types of alkali cations in the electrolyte;

FIG. 12A is a graphical plot of a modified cycle diagram for a DIC-retained cycle using pre-mixing and an alkalizing/capture volume (or flow rate) that is smaller than that of dealkalizing/release volume (or flow rate);

FIG. 12B is a graphical plot of a modified cycle diagram for a DIC-retained cycle pre-mixing using an alkalizing/capture volume (or flow rate) that is larger than that of dealkalizing/release volume (or flow rate);

FIG. 13 is a graphical plot of a modified cycle diagram for a DIC-retained cycle using micro-stepping to approach CO₂ isobars during capture and release;

FIG. 14 is a flow chart for a method of capturing CO₂ from a CO₂-lean gas according to one form of the present disclosure;

FIG. 15 is a flow chart for a method of capturing CO₂ from a CO₂-lean gas according to another form of the present disclosure; and

FIG. 16 is a flow chart for a method of capturing CO₂ from a CO₂-lean gas according to still another form of the present disclosure; and

FIG. 17 is a flow chart for a method of capturing CO₂ from a CO₂-lean gas according to yet another form of the present disclosure.

### DETAILED DESCRIPTION

The present disclosure provides methods for capturing CO₂ from air and other gases using an electrolytic cell. The methods include a capture process that provides a CO₂-rich gaseous stream in tandem with a CO₂-deficient gaseous stream as a result of alkalization and dealkalization of an aqueous electrolyte containing a given alkali cation.

In some variations, the methods include using an electrolytic cell with a CO₂ capture side, a CO₂ release side, at least one reversible, current-driven proton or hydroxide source or sink (source/sink), and at least one reversible, current-driven alkali-cation source/sink. As used herein, the phrase “reversible, current-driven proton or hydroxide source/sink” refers to any solid medium, soluble constituent, or solid/electrolyte interface (e.g., intercalation material, polymeric ion-exchange membrane, redox-active molecule, or supercapacitor material) that reversibly desorbs, transmits, or generates protons, hydronium, or hydroxide ions upon application of electronic or ionic current to it. Also, and as used herein, the phrase “reversible, current-driven alkali-cation source/sink” refers to any solid medium, soluble constituent, or solid/electrolyte interface (e.g., intercalation material, polymeric ion-exchange membrane, redox-active molecule, or supercapacitor material) that reversibly desorbs, transmits, or generates alkali cations upon application of electronic or ionic current to it.

The methods can include flowing a CO₂-lean gas into the CO₂ capture side of the electrolytic cell and executing at least one cycle that includes increasing an alkali-cation concentration of an electrolyte in the CO₂ capture side (referred to herein as “CO₂ capture side electrolyte) and decreasing an alkali-cation concentration of an electrolyte in the CO₂ release side (referred to herein as “CO₂ release side electrolyte”). Increasing the alkali-cation concentration of the CO₂ capture side electrolyte results in capturing CO₂ from the CO₂-lean gas and decreasing the alkali-cation concentration of the CO₂ release side electrolyte results in releasing CO₂ from the CO₂ release side electrolyte.

As used herein, the phrase “CO₂-lean gas” refers to a gas containing CO₂ and from which CO₂ is removed according to the teachings of the present disclosure. In some variations, the CO₂-lean gas is air with about 400 ppm CO₂, while in other variations the CO₂-lean gas is a flue gas from a combustion process containing CO₂. It should be understood that flue gases from combustion processes can contain anywhere from about 5 volume percent (vol. %) to about 15-20 vol. % of CO₂, depending on the type of fuel being burned and the particular combustion process used to burn the fuel.

In some variations, the at least one cycle includes pre-mixing the CO₂ capture side electrolyte with the CO₂ release side electrolyte. In the alternative, or in addition to, the at least one cycle includes isobar stepping during capturing CO₂ on the CO₂ capture side of the electrolytic cell and/or isobar stepping during release of CO₂ on the CO₂ capture side of the electrolytic cell. And in the alternative, or in addition to, the at least one cycle can include using dissimilar volumes of the CO₂ capture side electrolyte and the CO₂ release side electrolyte. As used herein, the phrase “isobar stepping” refers to a sequence of discrete CO₂ capture or CO₂ release steps between which incremental alkalization or dealkalization processes are used, as effected by a single electrochemical or a multiplicity of such.

In some variations, the at least one reversible, current-driven proton or hydroxide source/sink is at least one solid proton-intercalation electrode, e.g., at least one α-K_{0.05}MnO₂ electrode, Co-substituted Ni(OH)₂ electrode, Na₂TiV(PO₄)₃ electrode, a metal hydride electrode such as a LaNi₄Al electrode, among others. In some variations, the at least one reversible, current-driven alkali-cation source/sink is a cation-exchange membrane. In other variations, the at least one reversible, current-driven alkali-cation source/sink is an alkali-cation intercalation electrode.

The electrolyte in the electrolytic cell can be any alkali-cation bicarbonate/carbonate electrolyte suitable for capturing and releasing CO₂ per the teaching of the present disclosure. Non-limiting examples of the electrolyte include a lithium-based electrolyte, a potassium-based electrolyte, a sodium-based electrolyte, a rubidium-based electrolyte, a cesium-based electrolyte, a francium-based electrolyte, and combinations thereof, among others. In addition, the electrolyte can include one or more of a proton-chelating additive, a hydroxide-chelating additive, a carbonate-chelating additive, and/or a bicarbonate-chelating additive, as well as proton-coupled electron-transfer molecules. Non-limiting examples of such chelating additives include acetate anions, (mono- or di-hydrogen)phosphate anions, or guanidinium cations and non-limiting examples of proton-coupled electron-transfer molecules include quinones, their derivatives, and their various substituted forms.

In some variations, the at least one cycle has a CO₂ transfer charge efficiency ‘Λ_{CO2}’ defined by the relationship Λ_{CO2}=Δc_{DIC}/Δc_{tot,K+}, where Δc_{DIC} is the difference in dissolved inorganic carbon between the CO₂ capture side and CO₂ release side, Δ_{ctot,K+} is the swing of the alkali-cation concentration between the CO₂ capture side and CO₂ release side, and Λ_{CO2}>0.

In an effort to better embody the teachings of the present disclosure and yet not limit the scope thereof in any manner, a theoretical basis, experimental details, and examples of the methods disclosed herein are provided below.

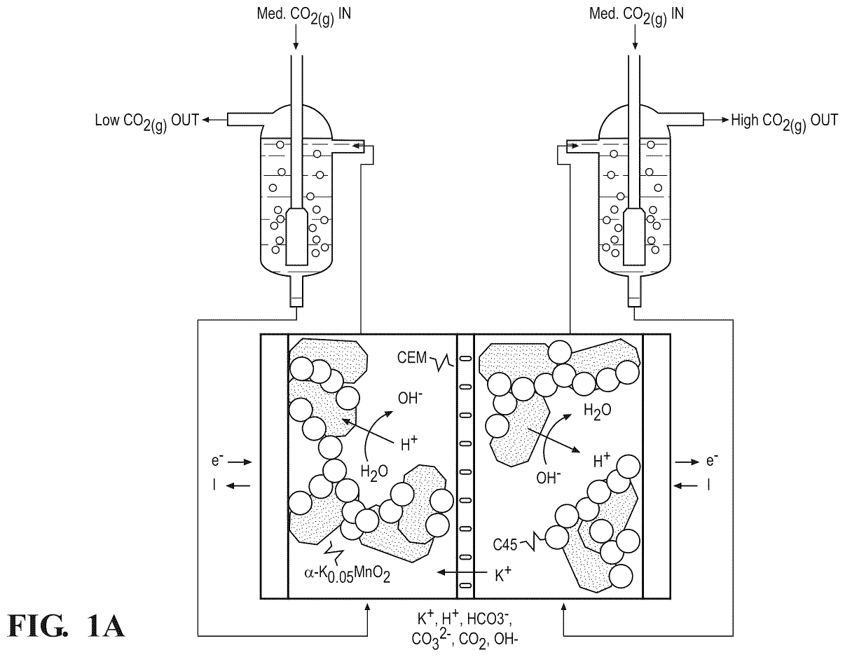

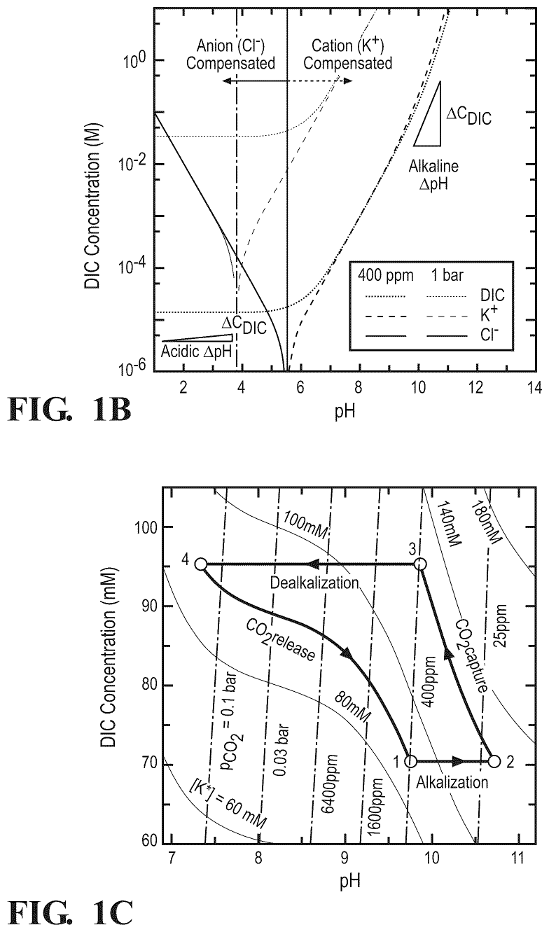

Referring to FIG. 1A, a bench-scale proton intercalation CO₂ capture apparatus (also referred to herein simply as “apparatus”) using alkaline electrolyte was used to demonstrate the methods according to the teachings of the present disclosure. The apparatus achieved direct air capture (DAC) of CO₂ using proton intercalation within α-K_{0.05}MnO₂ electrodes an alkaline electrolyte containing substantial dissolved inorganic carbon (DIC). The α-K_{0.05}MnO₂ electrodes were in the form of aggregated, crystalline nanorod α-K_{0.05}MnO₂ obtained from ERACHEM Comilog. The high surface area of the material facilitated reversible kinetics of proton intercalation and x-ray diffraction (XRD) patterns of the as-received material confirmed the α-phase of MnO₂ with alternating 2-by-2 and 1-by-1 tunnels into which protons intercalate. Voltage- and capacity-limited galvanostatic cycling of porous electrodes containing α-K_{0.05}MnO₂, conductive additive (e.g., Timcal Super “C45” conductive carbon black powder) and a binder (e.g., polyvinylidene fluoride powder) was performed in a flooded cell apparatus to characterize reversibility and stability. The results were benchmarked against electrolytic manganese dioxide (EMD, typically containing ε-, γ-, β-, and R—MnO₂ phases) that is commonly used in alkaline batteries. Also, the morphology of α-K_{0.05}MnO₂ was shown to be preserved after 100 galvanostatic cycles in a flooded cell, and elemental analysis thereof indicated that K⁺ ions remain pre-intercalated after such cycling despite the potential for protons to compete for the interstitial sites within α-MnO₂'s 2-by-2 tunnels that K⁺ likely occupies. Furthermore, the alignment of crystal planes observed from transmission electron microscopy (TEM) affirmed the topotactic nature of proton intercalation over 100 cycles, thereby illustrating that competition of K⁺ with protons for (de)intercalation was insignificant.

Humidified gas containing 400 ppm CO₂ in N₂ (labeled “Med. CO₂(g) IN” in FIG. 1A) was bubbled through a pair of fritted glass diffusers submerged in electrolyte recirculated from the FDI flow cell, and the α-K_{0.05}MnO₂ electrodes were separated by a cation-exchange membrane (CEM). The custom-designed flow cell illustrated in FIG. 1A was controlled using a potentiostat. Also, three-way Tube Pinch Valve inlet valves (IVs) and outlet valves (OVs) were used to direct electrolyte between a specific bubbler and a specific electrode. The productivity rate of CO₂ capture/release

$$‘ {{\dot{m}}_{CO}^{″}}_{2} ’$$

was determined from the CO₂ mass transferred ‘m_{CO}_{₂}’ over an elapsed time ‘Δt’ by integrating the measured flow rate and CO₂ concentration of effluent:

$${{\dot{m}}_{CO}^{″}}_{2} = {m}_{{CO}_{2}} / {A}_{CC} Δ t ,$$

where A_{CC} is current-collector area. Primary energy consumption was quantified based on cumulative electrical energy input during alkalization and dealkalization steps: SEC_{elec}=∫I·Vdt/m_{CO}_{₂} for a current I and cell voltage V.

Not being bound by theory, the methods are predicated or based on the high sensitivity of DIC concentration to pH changes when pH exceeds 7, and such an effect results from equilibrium between DIC formation reactions that occur under alkaline conditions. Particularly, the following reactions involving liquid and gaseous carbon-bearing solute prevail at equilibrium:

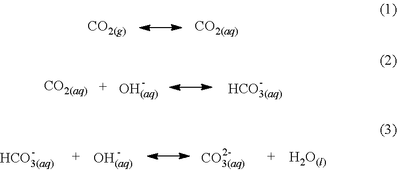

It should be understood from Reactions 1-3 above that by Le Chatelier's principle, higher alkalinity shifts DIC equilibrium towards CO₃²⁻ and HCO₃⁻ formation, and towards absorption of CO₂. For example, an increase in pH from 10 to 11 increases DIC concentration in equilibrium with 400 ppm CO_{2(g)} by 45-fold under alkaline conditions, whereas an increase in pH from 2 to 6 as disclosed in a previous study, also using proton-intercalation mediated pH swing, increases DIC concentration by only 1.7-fold under acidic conditions. The use of alkaline conditions also affects the polarity of counterions that are employed to compensate for charge neutrality when pH is shifted. For example, and with reference to FIG. 1B, inert cations having insignificant chemical interactions with electrolyte constituents must compensate charge for pH>5.5 in a capture scenario (400 ppm CO₂ for DAC) and for pH>3.9 in a practical release scenario (e.g., 1 bar CO₂), whereas inert anions having insignificant chemical interactions with electrolyte constituents must otherwise compensate charge. Accordingly, an alkaline electrolyte informs the use of alkali cations (e.g., K⁺) to compensate charge through a CEM that separates proton intercalation electrodes (e.g., see FIG. 1A), rather than using a Cl⁻-compensated electrolyte with an anion-exchange membrane as used in previous studies. The CO₂ capture process according to the methods of the present disclosure thus includes two key steps, which at present are performed asynchronously: (1) electrochemical alkalization/dealkalization; and (2) CO₂ capture/release.

Equilibrium theory was used to construct thermodynamic state diagrams for cycles that incorporate the two key steps mentioned above. Particularly, FIG. 1C illustrates the effect of electrochemical alkalization/dealkalization and CO₂ capture/release on the DIC concentration and pH during a single thermodynamic cycle. The CO₂ capture (States 2 to 3) and release (States 4 to 1) use the pH swing caused by proton intercalation and deintercalation during dealkalization (States 3 to 4) and alkalization (States 1 to 2), respectively, to shift the solubility of DIC in a pair of separate electrolyte streams. States 3 and 1 are constrained by equilibria between feed gas and electrolyte at the end of capture and release steps, respectively. Accordingly, it should be understood from FIG. 1C that pH control of an alkali electrolyte can be used to capture and then release CO₂ from a CO₂-lean gas.

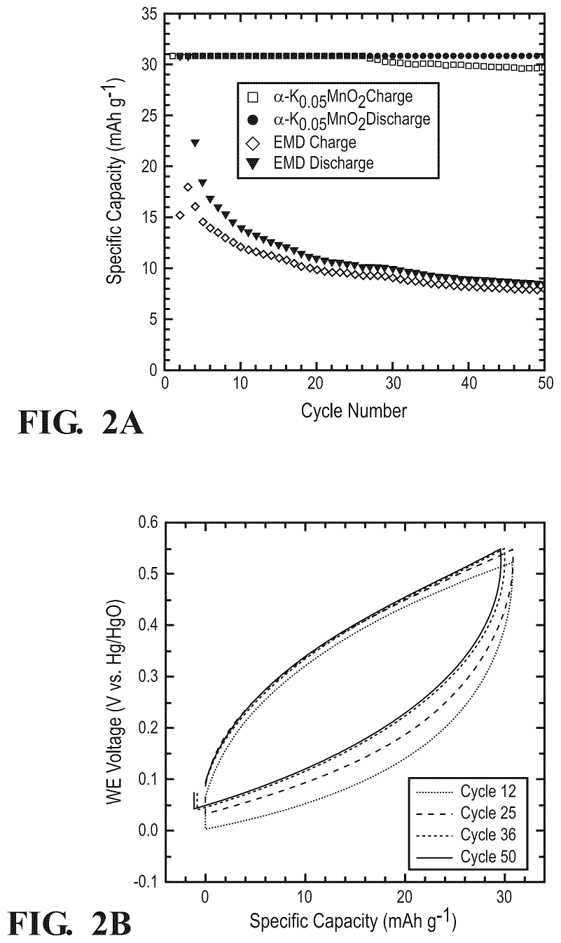

Referring to FIG. 2A, the capacity retention for galvanostatic cycling of α-K_{0.05}MnO₂ compared to electrolytic MnO₂ (EMD) electrodes in a DIC-buffered KOH electrolyte (pH≈9.8 containing 81 mM DIC and 104 mM K⁺) similar to the DIC-buffered KOH electrolyte used in CO₂ capture experiments is shown. Proton intercalation yields hydroxide upon partial reduction in the presence of H₂O:

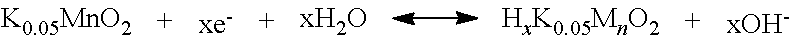

As observed from FIG. 2A, and when using the same working electrode (WE) voltage limits, the capacity of EMD electrodes rapidly decays over 50 cycles to about 8 mAh g⁻¹ which is far from a desired target capacity of 30.8 mAh g⁻¹. In contrast, the α-K_{0.05}MnO₂ electrode reached the target capacity for the first 26 cycles before the charge capacity falls slightly below the target and stabilizes.

The variations of voltage with state-of-charge also show evidence of the stability and reversibly of proton intercalation within α-K_{0.05}MnO₂. For example, FIG. 2B shows the α-K_{0.05}MnO₂ WE voltage versus specific capacity during several galvanostatic cycles with the bottom edge of each loop corresponding to a charge step and the upper edge corresponding to the subsequent discharge step. After about 25 cycles, the WE consistently reaches its voltage limit before reaching its capacity limit (as seen in the upper right corner), but the WE voltage at the end of the discharge step is shown to stabilize at a value above the lower limit of −50 mV vs. Hg/HgO. This repeatable variation of voltage from cycle-to-cycle suggests that the α-K_{0.05}MnO₂ electrode intercalates protons stably over the presently accessed state-of-charge range, and thus α-K_{0.05}MnO₂ was used in all subsequent CO₂ capture experiments.

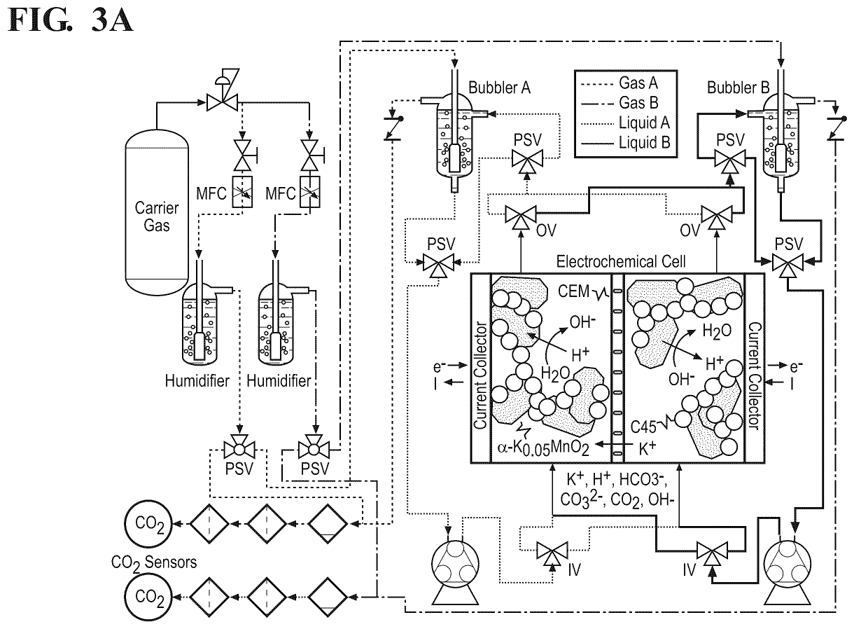

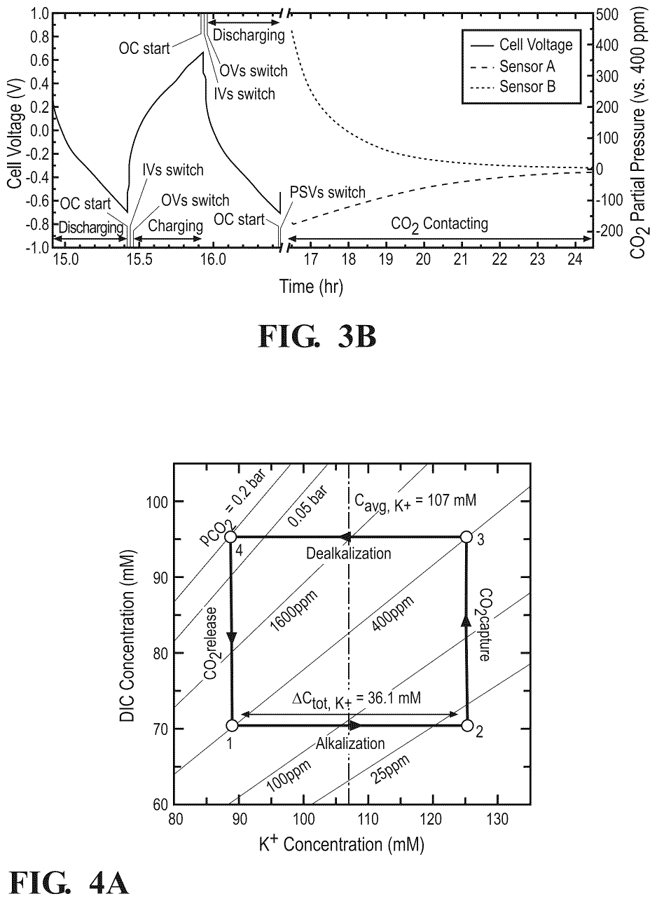

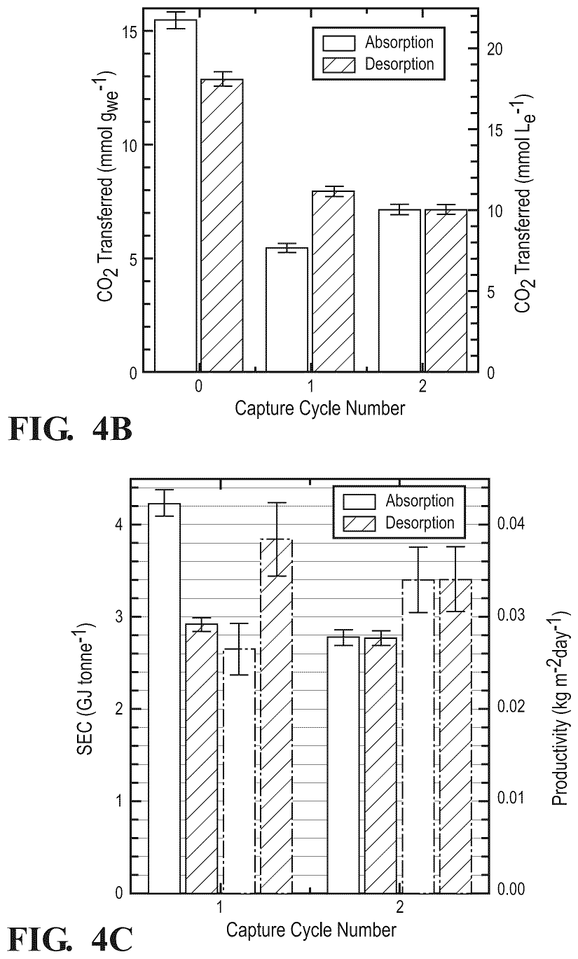

Referring to FIG. 3A, a more detailed view of the bench-scale apparatus mentioned above and used to characterize CO₂ capture using a symmetric proton-intercalation flow-cell coupled to bubblers used for CO₂ transfer between electrolyte and gas phases is shown. All experiments were performed in asynchronous fashion by first preparing solutions corresponding to States 2 and 4 of the felicitous cycle depicted in FIGS. 1C and 4A with a targeted K⁺ swing of Δc_{tot,K}_{⁺}=36 mM and a mean K⁺ concentration c_{ave,K}_{⁺}=107 mM. Asynchronous cycling was chosen to decouple the impact of process flow rates on electrochemical and gas/liquid mass-transfer unit operations, though synchronous embodiments can be effected using optimized flow rates. Thus, each experiment was initialized with a capture step to proceed from State 2 to 3 and with a release step from State 4 to 1, where both such steps bubbled N₂ feed gas containing 400 ppm CO₂ through the electrolyte. These steps constituted Capture Cycle 0 because capture and release were performed using prepared electrolytes, rather than using solutions that are alkalized and dealkalized electrochemically. The electrolyte at State 4 was DIC-rich relative to 400 ppm CO_{2(g)} while the other (State 2) was DIC-deficient, leading to CO_{2(aq)} desorption and absorption, respectively. The downstream gas-phase CO₂ concentration increases and decreases, respectively, while electrolyte composition approaches States 1 and 3 as capture and release steps terminate, as shown for later capture and release steps illustrated in FIG. 3B.

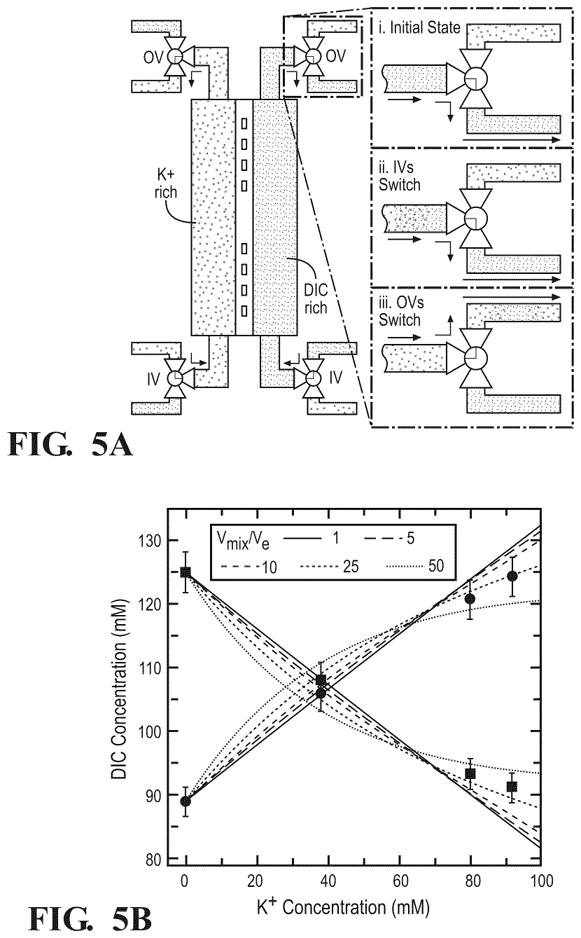

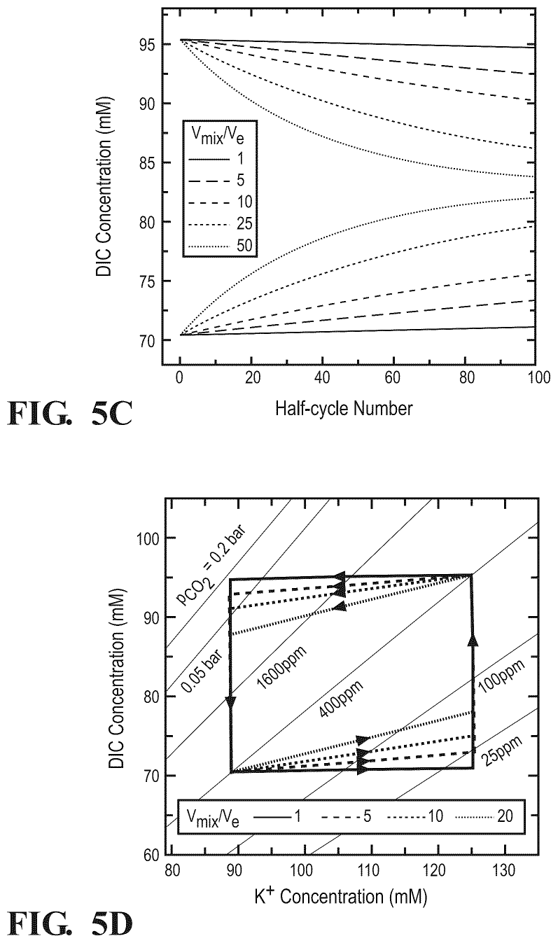

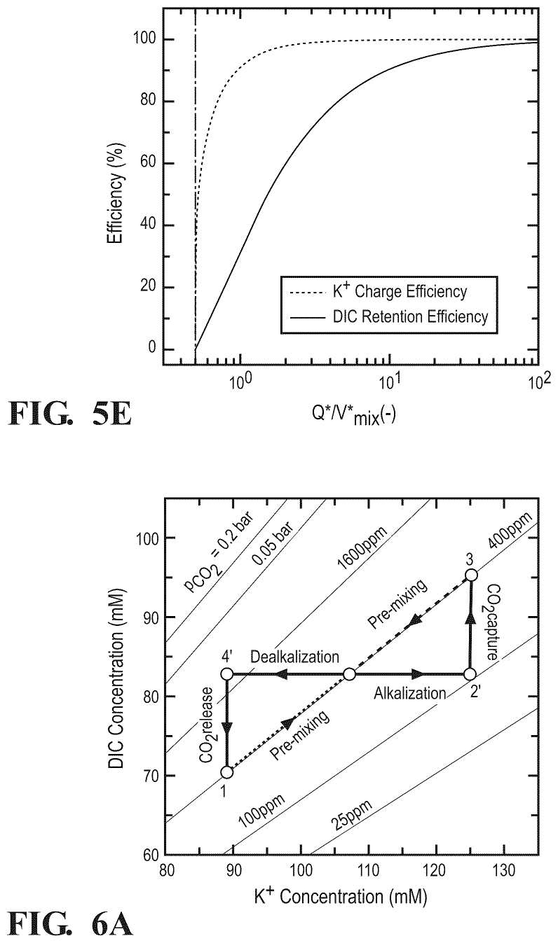

Electrochemical alkalization and dealkalization steps were then conducted by actuating process switch valves (PSVs, FIG. 3A) that diverted the CO₂-lean gas away from both bubblers to initiate Capture Cycle 1. Alkalization of the CO₂ capture side electrolyte advanced from State 1 to 2 and dealkalization of the CO₂ capture side electrolyte advanced from State 3 to 4 according to the felicitous cycle of FIGS. 1C and 4A. During such steps electrolyte was recirculated between each bubbler's reservoir and each electrode within the electrochemical cell with stagnant CO₂-lean gas in each bubbler's head-space. As current was applied to the electrochemical cell, porous α-K_{0.05}MnO₂ electrodes (de)intercalated protons to shift the pH of each stream, while K⁺ ions migrated across the CEM to maintain electroneutrality (FIG. 3A). While protons may have also migrated across the CEM, the K⁺ ions in the electrolyte were ~10⁶ times more concentrated than protons even at a pH of 7. Furthermore, as shown in the experimental data included in FIG. 5B discussed below, a substantial difference in K⁺ ion concentration between the two electrolyte streams was achieved. Thus, the migration of protons across the CEM was likely low relative to K⁺ ion migration.

Multiple half-cycles of electrochemical charge/discharge were used to accumulate a K⁺ swing near the target value of 35 mM, each of which used galvanostatic cycling during which voltage varied with time between predefined limits subject to a capacity limitation (FIG. 3B) and such a progressive generation of a K⁺ swing was evidenced from electrolyte conductivity measurements. Before current was switched at the end of each electrochemical half-cycle, inlet valves (IVs) were used to redirect electrolyte flow to the opposite half-cell (FIG. 3A) to produce pseudo-continuous cycling. After a short delay to allow the switched electrolyte streams to just reach the cell outlet, outlet valves (OVs) were then switched to redirect flow to the opposite bubbler reservoir (FIG. 3A) such that the volume of electrolyte that mixed between bubbler reservoirs was minimized. The current was then switched to the opposite direction. This process ensured that one electrolyte stream always lost H⁺ and gained K⁺ during alkalization while the other electrolyte stream always gained H⁺ and lost K⁺ during dealkalization.

After completing alkalization and dealkalization, PSVs were then switched to conduct capture and release on the CO₂-lean gas that flowed through the bubbler reservoir. After 8 hours of capture and release (FIG. 3B), PSVs were then switched again to begin alkalization and dealkalization steps for Capture Cycle 2. Using such a recursive sequence ultimately produced a limiting capture cycle for which cycle-to-cycle variations were insignificant, with as many as six complete capture cycles, including a total of 264 electrochemical half-cycles, completed to demonstrate that a limit cycle existed.

It should be understood that FIG. 3A illustrates voltage being applied to the electrochemical cell such that alkalinization of the left hand side (LHS) half cell is occurring and K⁺ ions are migrating or diffusing into the LHS half cell. Accordingly, the LHS half cell illustrated in FIG. 3A is the CO₂ capture side, and the electrolyte in the LHS half cell is the CO₂ capture side electrolyte. The right hand side (RHS) half cell illustrated in FIG. 3A is the CO₂ release side, and the electrolyte in the RHS half cell is the CO₂ release side electrolyte. In addition, and at a predefined time, the current applied to the electrochemical cell is reversed such that K⁺ ions migrate and/or diffuse into the RHS half cell (not shown), the RHS half cell becomes the CO₂ capture side, the electrolyte in the RHS half cell is the CO₂ capture side electrolyte, the LHS half cell becomes the CO₂ capture side, and the electrolyte in the LHS half cell is the CO₂ release side electrolyte.

Results from asynchronous capture experiments were obtained by mimicking the cycle illustrated in FIG. 4A. State variables DIC concentration and K⁺ were used/adopted, in contrast to DIC concentration and pH illustrated in FIG. 1C. Equilibrium between and within liquid and gas phases enabled the thermodynamic state of both phases to be specified uniquely in terms of the DIC concentration and K⁺ state variables. Also, the capture cycle illustrated in FIG. 4A is referred to as retained DIC because such a cycle attempts to retain DIC concentrations used during alkalization and dealkalization, i.e., after release (State 1) and capture (State 3), respectively, at the DIC concentrations possessed by the electrolyte. It should be understood that ideal DIC retention produces horizontal paths between States 1 and 2 and between States 3 and 4. And because K⁺ concentrations are unchanged by capture and release steps, vertical paths are produced between States 4 and 1 and between States 2 and 3, resulting in the ideal cycle shown in FIG. 4A having a rectangular shape.

Referring to FIGS. 4B-4C, results for an initial capture/release step (Capture Cycle 0) followed by two full capture cycles that each first use an alkalization/dealkalization step and a capture/release step are shown. The maximum theoretical CO₂ transfer during the contacting step was 24.4 mmol Lₑ⁻¹ (per liter of electrolyte), based on the chosen extent of alkalization (35 mM) and mean K⁺ concentration (100 mM). The desorbing stream of the first contacting step (Capture Cycle 0) is an exception, with a maximum CO₂ transfer of 18.8 mmol Lₑ⁻¹ due to the substitution of CO_{2(aq)} with KHCO₃ when preparing the electrolyte. Based on chemical equilibrium analysis, the theoretical CO₂ transfer during subsequent capture cycles was not greatly affected (<1% change) by this discrepancy.

In Capture Cycle 0, both electrolyte streams achieved CO₂ transfer near theoretical expectations, i.e., 89% and 96% for the absorbing and desorbing streams, respectively, thereby validating the use of the gas sensing and management apparatus employed in the apparatus illustrated in FIG. 3A. During subsequent cycles, CO₂ transfer decreased to a steady value, ending at an average of 7.15 mmol g_{we}⁻¹ (per gram of cast working electrode), which is 50.5% of the average CO₂ transfer of Capture Cycle 0. This suggests the system approached a limiting capture cycle, as predicted. Likewise, the electrical specific energy consumption (SEC) and productivity of CO₂ capture (FIG. 4C) were shown to be stable and nearly equivalent between the absorbing and desorbing streams by Capture Cycle 2, with averages of 2.77 GJ tonne⁻¹ and 0.0341 kg m⁻² day⁻¹. The number of CO₂ molecules captured per electron passed also steadied to an average of 0.245. However, the CO₂ transfer dropped to roughly half of that observed in Capture Cycle 0. This reduced CO₂ transfer was hypothesized to be a result of mixing between electrolyte streams during the (de)alkalization step, which was investigated to determine if mixing was likely a primary limiter of CO₂ transfer in the system discussed above, and used to create and test a new cycle that intentionally mixed electrolyte streams without using energy input to the electrochemical cell while mixing was intentionally induced. While not shown, in some variations such pre-mixing recovers electrical energy while intentionally mixing streams.

### Inter-Stream Mixing

The ability to utilize intercalation capacity toward ion separations requires the minimization of mixing between electrolytes of disparate ionic strength. Such mixing occurs when switching valves and current to produce a pseudo-continuous ion separations process when the electrolyte streams connected to either bubbler were swapped. Referring to FIG. 5A, an example of mixing that occurs is illustrated. For example, after IVs switch and the electrolyte in each half-cell is displaced by electrolyte from the opposite stream, OVs may switch too early, thus trapping some volume of disparate composition in each stream. Alternatively, if OVs switch too late, its effect on solution composition would be similar. Moreover, not all the electrolyte within the electrochemical cell is immediately displaced by the incoming electrolyte of disparate composition due to flow non-uniformity, which may lead to the apparent mixing between streams. In all cases, there is also hydrodynamic dispersion of solute (i.e., enhanced apparent diffusion caused by flow possessing finite shear rate) across the diffuse interface between electrolyte parcels having disparate composition.

Not being bound by theory, the mixing that occurs during valve switching was modeled as moderating the concentration of species i in either stream, where the change in concentration due to mixing, Δc_{mix,i}, is proportional to the concentration difference between the streams and to the ratio of the mixing volume Vₘᵢₓ (i.e. the effective volume of electrolyte transferred from one stream to the other) to the total volume of electrolyte in the stream Vₛₜᵣₑₐₘ:

$$Δ {c}_{mix , i} = \frac{{c}_{i}^{d} - {c}_{i}^{a}}{2} \cdot \frac{{V}_{mix}}{{V}_{stream}} \qquad ( 4 )$$

### Here,

$${c}_{i}^{d} and {c}_{i}^{a}$$

are the concentrations of species i on de-alkalized and alkalized sides of the electrochemical cell, respectively.

Unlike DIC, electrochemically driven K⁺ transfer between the electrolyte streams occurs during (de)alkalization steps. The K⁺ concentration change Δc_{e,K}_{⁺} caused by a single half-cycle of our electrochemical cell thus corresponds to the charge stored in the electrode as a result of Faradaic balance:

$$Δ {c}_{e , {K}^{+}} = \frac{{q}_{A M} {ρ}_{A M} {v}_{A M} {V}_{e}}{{V}_{stream} F} \qquad ( 5 )$$

where q_{AM}, ν_{AM}, and ρ_{AM} are the specific capacity, volume fraction, and density of the active proton-intercalation material, respectively, Vₑ is the superficial volume of the electrode, and F is Faraday's constant. Thus, K⁺ concentration changes by both Δc_{mix,K}_{⁺} and Δc_{e,K}_{⁺}, while DIC concentration changes only by Δc_{mix,DIC} during each half cycle, with such effects accounted for by using a discrete-time balance of the solute mass between successive half cycles.

For a (de)alkalization process using many half-cycles in total, each solute's concentration was approximated as a continuous function of half-cycle number n to yield two differential equations that were solved to find explicit formulas (6) and (7) below for the variation of K⁺ and DIC concentration with half-cycle number n:

$${c}_{{K}^{+}}^{d / a} ( n ) = \pm ( \frac{1}{2} Δ {c}_{tot , {K}^{+}} + \frac{1 - {V}_{r}}{{V}_{r}} Δ {c}_{e , {K}^{+}} ) {e}^{( - {V}_{r} n )} ∓ \frac{1 - {V}_{r}}{{V}_{r}} Δ {c}_{e , {K}^{+}} + {c}_{ave , {K}^{+}} \qquad ( 6 )$$

$${c}_{DIC}^{d / a} ( n ) = \pm \frac{1}{2} Δ {c}_{tot , DIC} {e}^{( - {V}_{r} n )} + {c}_{ave , DIC} \qquad ( 7 )$$

Here, the superscripts d and a denote de-alkalization and alkalization, respectively, Δc_{tot,K}_{⁺} and c_{ave,K}_{⁺} are the initial K⁺ concentration difference and the average K⁺ concentration among the two streams, respectively, Δc_{tot,DIC} and c_{ave,DIC} are the initial DIC concentration difference and the average DIC concentration among the two streams, respectively, and Vᵣ is the following ratio: Vₘᵢₓ/Vₛₜᵣₑₐₘ. The results for the inter-stream mixing discussed above are shown in FIGS. 5B-5E with the ratio of mixing volume to superficial electrode volume (Vₘᵢₓ/Vₑ) used as a nondimensional representation of the strength of mixing.

Referring particularly to FIG. 5B, the K⁺ concentration becomes more disparate in the respective streams for a large number of half cycles when Vₘᵢₓ/Vₑ is small, which indicates weak mixing, and the disparity in K⁺ concentration is suppressed for greater mixing volume ratios Vₘᵢₓ/Vₑ. Larger mixing volumes correspond to a greater mixing effect than the (de)alkalization process can counteract, and for larger mixing volumes, the number of (de)alkalization cycles needed to achieve the target K⁺ change Δc_{tot,K}_{⁺} increases, thus increasing capture cycle energy consumption.

Still referring to FIG. 5B, there also exists a certain half-cycle number at which the K⁺ concentration within the alkalized and dealkalized streams becomes equal, and as the intensity of mixing is increased as a result of larger Vₘᵢₓ/Vₑ, the associated half-cycle at which concentrations intersect is reached faster. However, for half cycles that follow after this intersection point the difference in c_{K}_{⁺} between streams increases at a reduced rate as (de)alkalization works against K⁺ mixing. Furthermore, if mixing volume becomes excessively large (Vₘᵢₓ/Vₑ>25) the electrochemical cell is incapable of achieving a concentration difference that matches the targeted difference (Δc_{tot,K}_{⁺}) even for an infinite number of half cycles. This behavior can be attributed to the interplay between K⁺ transfer induced by proton intercalation and inter-stream mixing. For a given stream, K⁺ transfer induced by proton intercalation acts with a constant rate of change for K⁺ concentration, while inter-stream mixing always biases K⁺ concentration toward c_{ave,K}_{⁺}. Consequently, prior to reaching its intersection half-cycle, both mixing and K⁺ transfer induced by proton intercalation act to accelerate overall K⁺ transfer. However, after its intersection half-cycle, these mechanisms operate in opposing directions, leading to the deceleration of overall K⁺ transfer rate. It should be understood that FIG. 5B shows experimental measurements of K⁺ concentration agree with the pre-mixing theory using Vₘᵢₓ/Vₑ between 10 and 25. In contrast, DIC concentration in the two streams asymptotically approaches c_{ave,DIC} for large half-cycle number because DIC concentration is influenced solely by mixing and not by proton intercalation. This moderation of DIC occurs more rapidly for larger Vₘᵢₓ/Vₑ.

Referring to FIG. 5D, such inter-stream mixing influences the thermodynamic cycle diagram for CO₂ capture. Assuming that the same extent of (de)alkalization is achieved regardless of mixing's extent, a higher mixing volume leads to more complete moderation of DIC among the two streams, resulting in less CO₂ transfer during subsequent capture and release steps due to a lower swing in DIC. This effect indicates that mixing is more detrimental to achieving a desired extent of CO₂ transfer than to achieving a desired extent of (de)alkalization. In the limit of infinite mixing between the two streams, the extent of CO₂ transfer is bounded to 50% of its theoretical maximum, assuming that the ideal extent of (de)alkalization is achieved. The fact that experimental results showed that the capture and release steps of Capture Cycle 1 yielded roughly 50% of the CO₂ transfer of Capture Cycle 0 suggests that electrolyte mixing is significant.

Such mixing also affects the efficiency of the (de)alkalization process as illustrated in FIG. 5E. To quantify efficiency losses, a charge efficiency Λ_{K}_{⁺} for K⁺ transfer and a retention efficiency η_{DIC} for DIC in terms of initial and final K⁺ and DIC concentrations were defined as:

$${Λ}_{{K}^{+}} = \vert \frac{{c}_{{K}^{+}}^{d / a} ( {n}_{end} ) - {c}_{initial , {K}^{+}}^{d / a}}{{n}_{end} Δ {c}_{e , {K}^{+}}} \vert \qquad ( 8 )$$

$${η}_{DIC} = \frac{{c}_{DIC}^{d} ( {n}_{end} ) - {c}_{DIC}^{a} ( {n}_{end} )}{{c}_{initial , DIC}^{d} - {c}_{initial , DIC}^{a}} \qquad ( 9 )$$

where n_{end} refers to the end point of the half cycle when the streams achieve Δc_{tot,K}_{⁺} for certain initial concentrations:

$${c}_{initial , {K}^{+}}^{d / a} and {c}_{initial , DIC}^{d / a} .$$

The charge efficiency Λ_{K}_{⁺} and the retention efficiency η_{DIC} are shown to depend solely on the ratio of a dimensionless specific capacity parameter Q*=m_{AM}q_{AM}/FΔc_{tot,K}_{⁺}Vₚ to a dimensionless mixing volume parameter

$${V}_{mix}^{*} = {V}_{mix} / {V}_{p} ,$$

where m_{AM} is the mass of active-material in one electrode and Vₚ is electrode pore volume:

$${Λ}_{{K}^{+}} = - {\{ \frac{{Q}^{*}}{{V}_{mix}^{*}} ln ( \frac{\frac{{Q}^{*}}{{V}_{mix}^{*}} - \frac{1}{2}}{\frac{{Q}^{*}}{{V}_{mix}^{*}} + \frac{1}{2}} ) \}}^{- 1} \qquad ( 10 )$$

$${Λ}_{DIC} = \frac{\frac{{Q}^{*}}{{V}_{mix}^{*}} - \frac{1}{2}}{\frac{{Q}^{*}}{{V}_{mix}^{*}} + \frac{1}{2}} \qquad ( 11 )$$

### Here,

$${Q}^{*} / {V}_{m i x}^{*}$$

represents the ratio of the strength of electrochemical separation to the strength of mixing. FIG. 5E shows that for both such efficiencies to exceed 90%, the ratio

$${Q}^{*} / {V}_{m i x}^{*}$$

must exceed 10. This condition requires either a large electrode specific capacity or a small mixing volume. Considering a common value of

$${Q}^{*} / {V}_{mix}^{*} , {Λ}_{{K}^{+}}$$

is consistently higher than η_{DIC}. For a given improvement in

$${Q}^{*} / {V}_{m i x}^{*} when {Q}^{*} / {V}_{m i x}^{*}$$

is small, much greater gains in K⁺ charge efficiency can be made than for DIC retention efficiency.
Capture Cycle with Pre-Mixed DIC

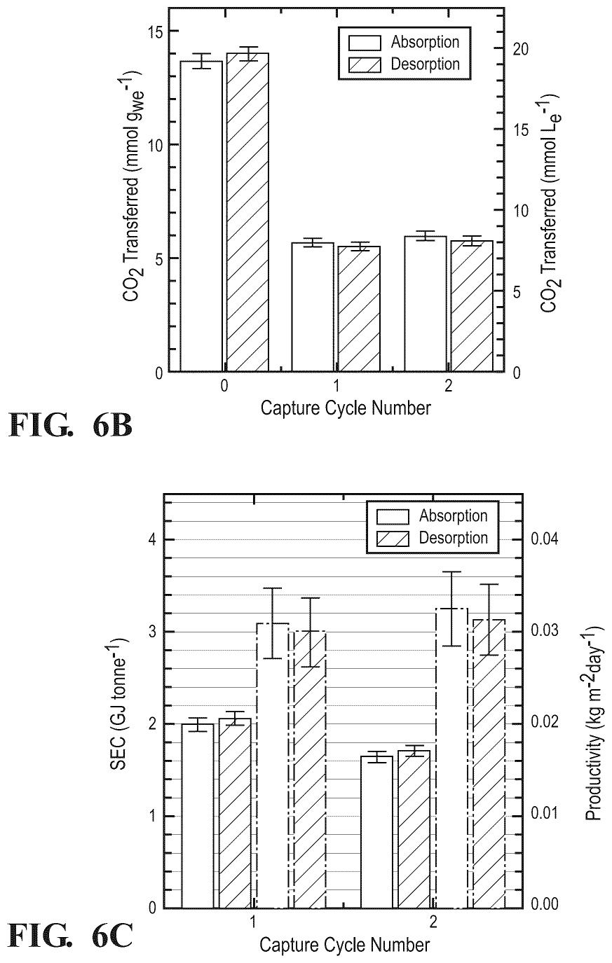

The results of the pre-mixing theory discussed above suggests inter-stream mixing impacts CO₂ capture performance, primarily by causing DIC concentration to be moderated. To improve the efficiency of the (de)alkalization process, a pre-mixing phase immediately after capture and release was introduced to advance the extent of K⁺ swing that occurs prior to using electrical energy to generate it. A modified thermodynamic cycle diagram for such a pre-mixing is shown in FIG. 6A with an additional State ‘m’ that is realized by mixing State-1 and State-3 electrolytes completely. Such pre-mixing was achieved in practice by intentionally circulating effluent from one half-cell into the bubbler reservoir from which the other half-cell draws electrolyte in parallel “figure-eight” flow loops for one hour. This flow resulted in two electrolyte streams of identical DIC and K⁺ concentrations. Given the results from FIG. 4B suggest sufficient mixing to bring the CO₂ transfer to 50% of that of the initial contacting step, it is reasoned that the (de)alkalization process could be shortened by thoroughly mixing the electrolytes to eliminate the initial difference in K⁺ concentration that the process previously overcame via electrochemical separation. As a result, the use of such a pre-mixed cycle was not expected to reduce CO₂ transfer substantially, given the extreme extent of DIC mixing that was deduced from our prior experiments. Furthermore, by reducing the number of cycles to roughly half those required to achieve the K⁺-swing target that was used earlier, energy consumption and productivity were expected to improve. Despite this expectation, in practice it was determined that greater than half of the galvanostatic cycles used previously are needed for full (de)alkalization (FIG. 6A).

The results of the asynchronous capture test with pre-mixing are shown in FIGS. 6B-6C. The number of galvanostatic cycles was reduced from 16 to 12, considering the addition of pre-mixing. Despite pre-mixing the electrolytes, the average CO₂ transfer extent of Capture Cycle 2 was 5.85 mmol g_{we}⁻¹ (FIG. 6B), which deviates by only 18% from the results of our capture cycle that aimed to retain DIC (FIG. 4B). Compared to the initial capture and release step, Capture Cycle 2 yielded 42% of the CO₂ transfer. Despite this lower CO₂ transfer, Capture Cycle 2 productivities when using pre-mixing reached 0.0319 kg m⁻² day⁻¹ on average, which is only 6.3% lower than those of the test without pre-mixing. Furthermore, the number of CO₂ molecules captured per electron passed rose 9.1% to 0.268. Most notably, the energy consumption of Capture Cycle 2 was only 1.68 GJ tonne⁻¹ on average, which is 39% lower than the case without pre-mixing.

While the preceding results demonstrate the convergence of adsorption and desorption CO₂ transfer after two complete capture cycles, two additional experiments were performed with at least five capture cycles. The first of such experiments was performed using 400 ppm CO₂ in N₂, whereas the second of such experiments used 400 ppm CO₂ in a 79:21 mixture of N₂ and O₂ to probe the effect of O₂ on the process. The performance using either gas resulted in similar CO₂ transfer, energy consumption, and productivity to the results in FIGS. 6A-6C. These experiments also demonstrated the durability of α-K_{0.05}MnO₂ under the present conditions, given that they included 264 total half-cycles of robust electrochemical cycling that produced sustained CO₂ capture performance after Capture Cycle 1. Robust performance in the presence of dissolved O₂ also indicates that parasitic O₂ reduction is insignificant.

The reduced CO₂ transfer observed in pre-mixed tests could be caused by a greater degree of DIC moderation between the two streams induced by pre-mixing when compared to DIC moderation induced by mixing during valve switching events. Moreover, the fact that the CO₂ transferred during Capture Cycle 2 was less than 50% of that of the initial capture and release step suggests that there are more factors beyond mixing that cause reduced CO₂ transfer. For example, if the (de)alkalization process was incomplete, less CO₂ would be transferred during the subsequent capture/release step, since the change in DIC capacity depends directly on the extent of (de)alkalization.

To compare the performance of the CO₂ capture process according to the teachings of the present disclosure with results in similar studies, three different SEC values were analyzed. First, the electrical SEC from Capture Cycle 2 of the pre-mixed capture experiment, which represents a lower limit, was considered. Second, the work required to compress 400 ppm outlet gas to 1 bar to the electrical energy consumption values was considered, as this compression step is practical for further processing or sequestration. At 25° C. an upper bound of 1.06 GJ tonne⁻¹ for virtual compression of pure CO₂ for a total SEC of 2.74 GJ tonne⁻¹ was estimated. Third, the work required for condensation of water vapor out of the CO₂ product stream, given that water produces a certain vapor pressure, was considered. At 25° C. an upper bound of 32.9 GJ tonne⁻¹ for condensation, leading to a total SEC of 35.6 GJ tonne⁻¹ was estimated. However, assuming high CO₂-transfer charge efficiency, the work required for condensation decreases precipitously at high release-side pressures.

Modest current density was used in the experiments to achieve a target specific capacity of 30.8 mAh g⁻¹ despite polarization nearing 330 mV, accounting for 22% of the cell voltage range used. At higher current densities, the cell voltage reached its limits before the electrodes reached their target capacity, leading to reduced extent of (de)alkalization. Moreover, once the duration of (dis)charge became voltage-limited, the specific capacity reduction compounds, further diminishing performance. There are several phenomena that contribute to such capacity reduction. Series resistance, accounting for roughly 25 Ω cm⁻² based on impedance characterization of the electrochemical cell, could feasibly contribute 90 mV of this polarization at 0.54 mA cm⁻² applied current, but this did not account for the full extent of polarization. Additionally, the low porosity (~20%) and the tortuosity of the electrodes may have impeded ion transport by offering limited electrode-electrolyte interface surface area and increasing ion transport path length. The tortuosity and low porosity may have also lead to the creation of dead volumes, wherein electrolyte flow is diminished or blocked entirely. Dead volumes in turn may have led to the local depletion of aqueous reactants, rising overpotentials, and thus capacity reduction. Electrolyte flow may have also biased the solute concentration and reaction-rate distributions within electrodes to affect impedance and the productivity of the CO₂ capture process according to the teachings of the present disclosure could be improved by increasing the reversible specific capacity and current-density capability of the proton-intercalation electrodes used.

Regarding release side conditions for the methods disclosed herein, certain release-side (p_{CO}_{₂}_{,rel}) and capture-side (p_{CO}_{₂}_{,cap}) CO₂ pressures were evaluated with DIC-retained or pre-mixed cycle determined to be uniquely represented by (i) its K⁺ swing Δc_{tot,K}_{⁺} and (ii) its post-release (State 1) K⁺ concentration c_{min,K}_{⁺}. Also, an equilibrium thermodynamic analysis was used to predict DIC swing Δc_{tot,DIC} as a function of Δc_{tot,K}_{⁺} and c_{min,K}_{⁺}. This relationship was predicted by fixing p_{CO}_{₂}_{,cap} at 400 ppm for State 3, while fixing a certain value of p_{CO}_{₂}_{,rel} for State 1. The c_{min,K}_{⁺} determines c_{K}_{⁺} for States 1 and 4, and c_{K}_{⁺} for States 2 and 3 were set to c_{min,K}_{⁺}+Δc_{tot,K}_{⁺}. The feasibility of a given cycle was assessed using a CO₂-transfer charge efficiency Λ_{CO}_{₂}, defined as the ratio of DIC swing to K⁺ swing:

$${Λ}_{C {O}_{2}} = \frac{Δ {c}_{tot , DIC}}{Δ {c}_{tot , {K}^{+}}} \qquad ( 12 )$$

It should be understood that if Δc_{tot,DIC} becomes negative for a specified Δc_{tot,K}_{⁺} level, a feasible capture cycle cannot be formed because CO₂ would be captured at high pressure and released at low pressure. Thus, Λ_{CO}_{₂}>0 dictates a feasible capture cycle with Λ_{CO}_{₂}=0 defining the transition between feasible and infeasible regimes. By analyzing Λ_{CO}_{₂} as a function of c_{min,K}_{⁺}, Δc_{tot,K}_{⁺}, and the release-side CO₂ partial pressure p_{CO}_{₂}_{,rel}, the appropriate electrolyte conditions can be identified to sustain feasible operation even at elevated release pressures.

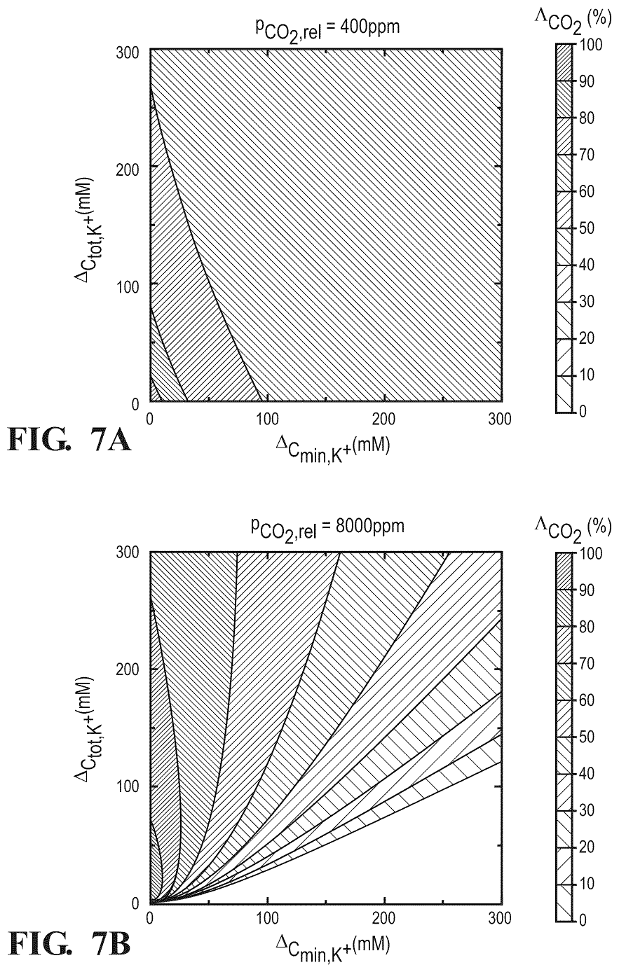

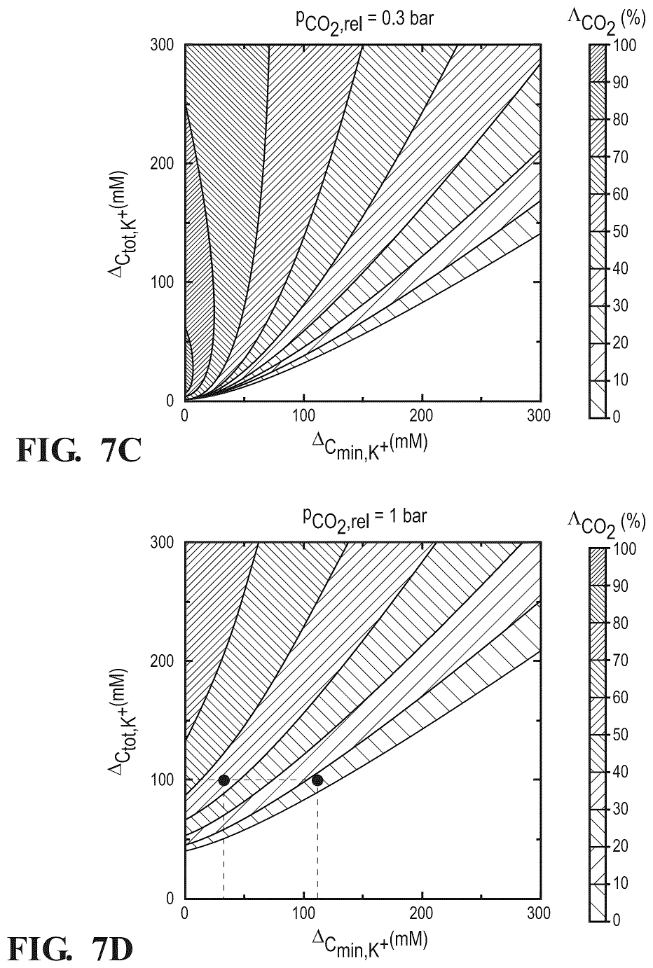

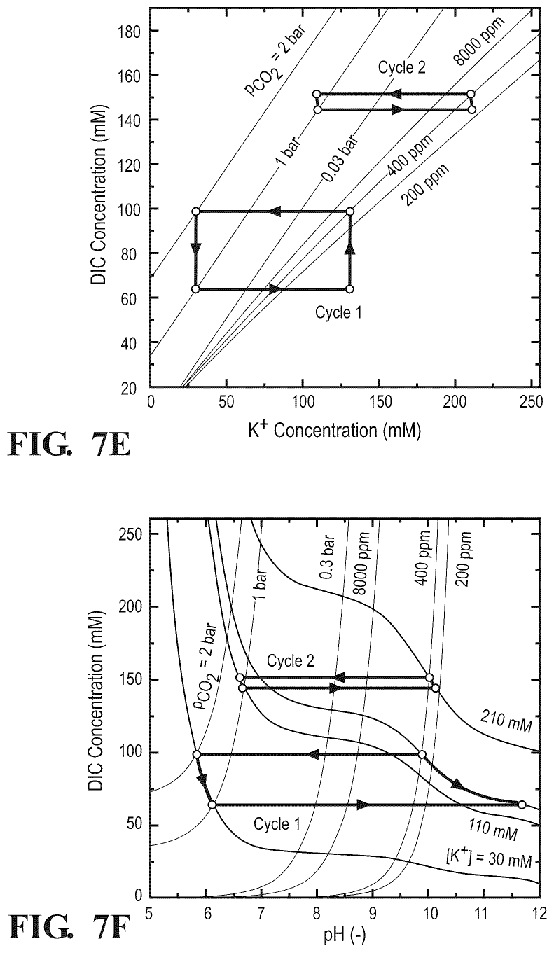

FIGS. 7A-7D illustrate that the feasible set of capture cycles (Λ_{CO}_{₂}>0) contracts as release-side CO₂ pressure increases. Specifically, high release-side CO₂ pressure becomes feasible for small enough c_{min,K}_{⁺} levels and large enough Δc_{tot,K}_{⁺} levels. In addition, the maximum achievable Λ decreases with increasing release-side CO₂ partial pressure. The reduction in CO₂ transfer at elevated p_{CO}_{₂}_{,rel} can be explained by Henry's law, i.e., as the gas-phase CO₂ pressure increases, the equilibrium concentration of dissolved CO₂ in the liquid phase also increases, thereby suppressing CO₂ release into the gas phase. This behavior represents a trade-off with the reduced energy demand for downstream compression. Nevertheless, FIG. 7D shows that Λ_{CO}_{₂} values up to 60% can be obtained at p_{CO}_{₂}_{,rel}=1 bar by minimizing c_{min,K}_{⁺} and maximizing Δc_{tot,K}_{⁺}, thereby enabling cycles that retain excellent CO₂ transfer even at practical release pressures.

FIGS. 7E-7F show the state diagrams for representative DIC-retained capture cycles that produce high (Cycle 1: 35%) and low (Cycle 2: 7%) CO₂-transfer charge efficiency when used with 1 bar release-side CO₂ pressure and 100 mM K⁺-swing. In the c_{DIC} versus c_{K}_{⁺} plane (FIG. 7E), selecting a lower c_{min,K}_{⁺} level as in Cycle 1 results in greater CO₂ transfer than does a higher c_{min,K}_{⁺} level as in Cycle 2. Here, the DIC swing for each cycle corresponds directly with its CO₂-transfer charge efficiency. This effect occurs because CO₂-pressure isobars are densely spaced for electrolytes with low c_{DIC} and c_{K}_{⁺} (FIG. 7E). Such dense spacing of isobars is caused by the suppression of dissolved CO₂ at the end of alkalization when DIC concentration is also small, as enabled by CO₃²⁻ promotion. For Cycle 1 its alkalization step with certain K⁺-swing induces a larger change in p_{CO}_{₂} between States 1 and 2, resulting in a greater DIC swing and thus enhanced CO₂ transfer. For Cycle 2 the same K⁺ swing leads to a smaller p_{CO}_{₂} change between these states, reducing DIC swing and limiting CO₂ transfer. Cycle 1 also shows a larger pH swing than Cycle 2 (FIG. 7F).

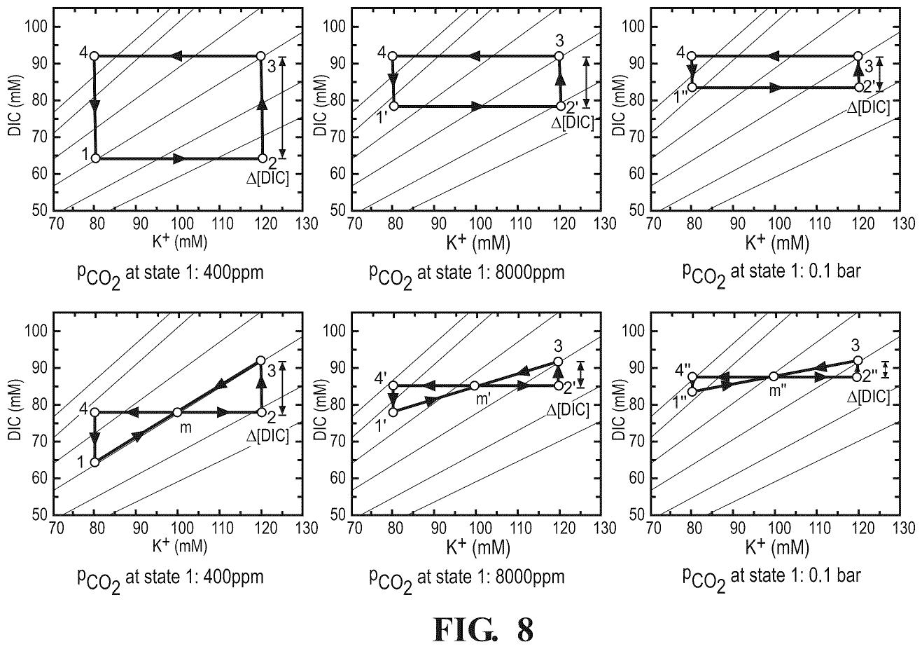

Regarding the effect of release-side CO₂ pressure, the CO₂ capture process according to the teachings of the present disclosure produces a CO₂-rich gaseous stream in tandem with a CO₂-deficient gaseous stream as a result of alkalization and dealkalization of an aqueous electrolyte containing a certain type of alkali cation. Representations of the process as a thermodynamic cycle are shown in FIG. 8 in the electrolyte concentration space of dissolved inorganic carbon (DIC) versus alkali cations. For a so-called DIC-retained cycle (top row of FIG. 8) ideal alkalization and dealkalization steps occur respectively between states 1 and 2 and 3 and 4 with a constant DIC level, whereas capture and release steps occur respectively between states 2 and 3 and 4 and 1 with a constant alkali-cation level. Here, states 1 and 3 are specified according to the partial pressure of gas-phase CO₂ with which DIC in the liquid electrolyte is in equilibrium. Thus, the top-left figure corresponds to capture of CO₂ from air (~400 ppm) and release of CO₂ to the same partial pressure (400 ppm). However, the use of such a low release-side pressure inevitably leads to either increased energy consumption or decreased product purity for the following reasons.

First, H₂O in the liquid-phase will inevitably be in equilibrium with the gas phase, corresponding to an H₂O vapor pressure at room temperature of 0.03 bar. Thus, a CO₂ partial pressure of 400 ppm would correspond to a mole fraction of only ~1% CO₂. Thus, H₂O would need to be condensed out of the gas in order to purify it, thus representing an energy penalty.

Second, neglecting the effect of volatilized H₂O in the gas phase, 400 ppm CO₂ gas would need to be compressed to at least a nominal pressure of 1 bar in order to be sequestered or valorized in some other way. This represents an additional energy penalty.

Third, other gases in air (namely O₂) can be transmitted through the electrolyte during capture to the release gas, albeit likely at a very slow rate. When high release-side pressure is used, the fraction of impurities due to such an effect is decreased.

FIG. 8 also shows the effect of release-side CO₂ pressure on DIC-retained and pre-mixed versions of our CO₂ capture cycle. The bottom row of subfigures represents the so-called pre-mixed cycle, wherein the DIC-retained cycle is modified by mixing the disparate electrolytes together after steps 1 and 3 but prior to steps 2 and 4. In each case, the extent of alkali-cation swing is fixed to 40 mM, but when the release-side pressure is increased there is a marked decrease in the corresponding DIC swing. This effect occurs because of the orientation and arrangement of the various CO₂ isobars in the space of DIC versus alkali cations. However, the marginal decrease in DIC swing that occurs as a result of increasing release-side pressure can be abated by judicious selection of electrolyte cycle parameters, namely the extent of alkali-cation swing and the minimum concentration of alkali cations.

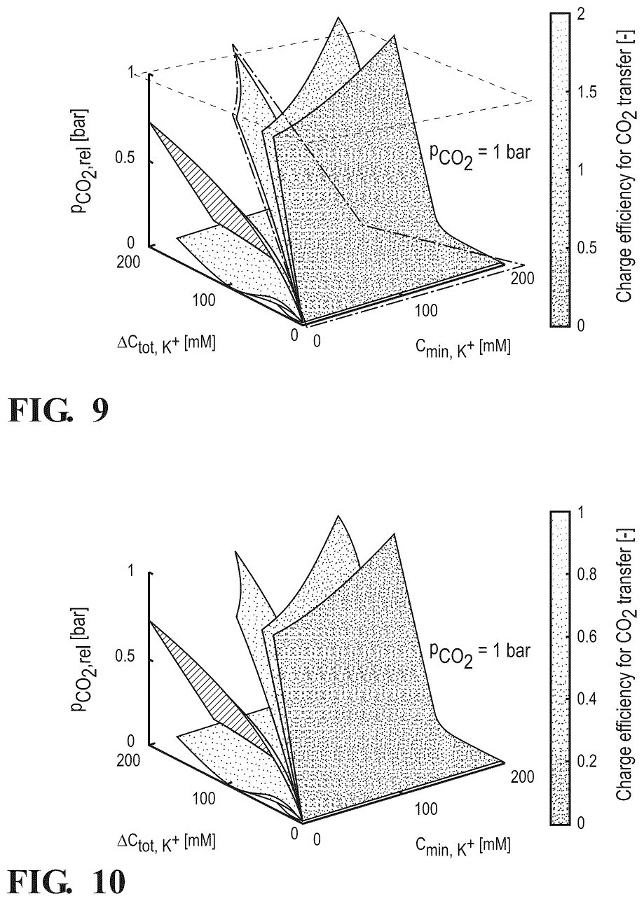

Accordingly, the achievable DIC swing as a function of (1) alkali-cation swing, (2) the minimum alkali-cation concentration, and (3) the release-side CO₂ partial pressure was analyzed with any combination of these three parameters representing a unique CO₂ capture cycle. Moreover, the charge efficiency for CO₂ transfer Λ as the ratio of DIC swing to alkali-cation swing for each such cycle was calculated. This parameter is a kind of Faradaic efficiency for the process. As mentioned above, feasible cycles are only formed for Λ>0, but in practice a sufficiently large Λ is desired to assure that feasible cycles are efficient enough. FIG. 9 shows the isosurfaces for certain values of Λ in such a cycle “space.” Here, the darkest grey isosurface corresponding to Λ=0 represents the set of different cycles which have infinitesimal DIC swing. Such cycles, referred to hereafter as “transition” cycles, bound the set of cycles that are feasible from those that are not feasible. The lighter grey isosurface bounded by a dashed line indicates the set of cycles that produce Λ=50%. The intersection of all such isosurfaces with the plane corresponding to 1 bar release-side CO₂ pressure indicates the range of feasible A values that can be produced using such a high release-side pressure. Here, it is shown that an alkali-cation swing of 100 mM with a minimum alkali-cation concentration of 0 mM can produce 50% charge efficiency with 1 bar release-side pressure, but there are additional cycles that can release at 1 bar provided that alkali-cation swing is increased beyond 100 mM.

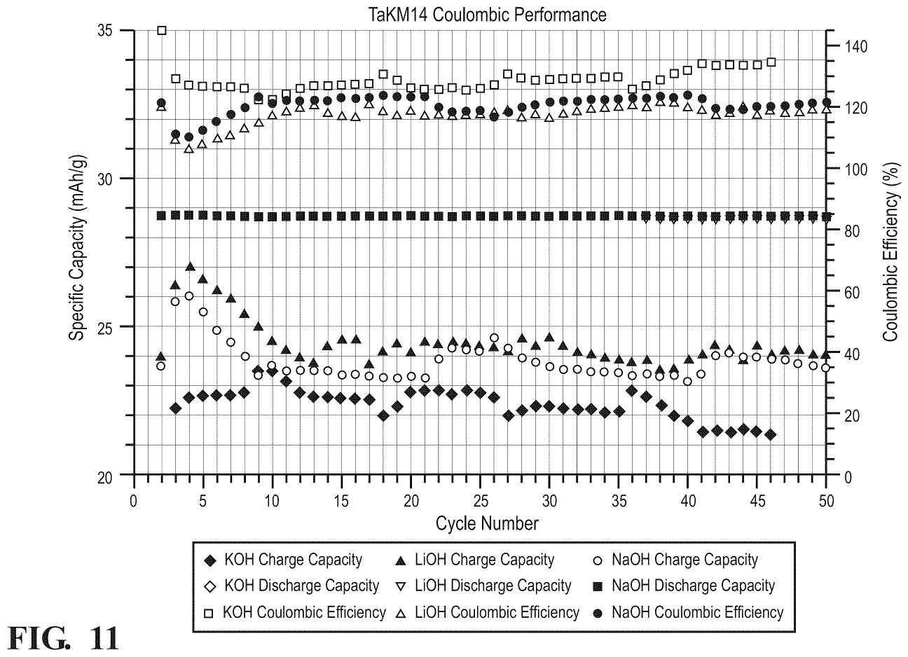

Similar conclusions can be drawn for the pre-mixed version of the cycle as illustrated by the bottom row in FIG. 8. That is, when pre-mixing is used with equal release-side and capture-side electrolyte volumes (asynchronous operation) or flow rates (synchronous operation), the extent of DIC swing is automatically cut in half because a pre-mixed state is introduced. Thus, the charge efficiency isosurfaces for pre-mixed cycles that are shown in FIG. 10 are half the magnitude of those shown for DIC-retained cycles (note scale of charger efficiency of CO₂ transfer legend on RHS of FIGS. 9-10).

It should be understood that other monovalent cations than K⁺ can be used to compensate charge. Most notably, the other alkali cations in the first column of the periodic table can be used: Li⁺, Na⁺, Rb⁺, Cs⁺, and Fr⁺. It is possible that other non-alkali cations that have stable monovalent oxidation states may additionally be used. For example, the ability of the α-K_{0.05}MnO₂ electrode material to intercalate protons from solutions containing Li⁺ or Na⁺ were tested and specific capacities were found to be similar to those obtained when using K⁺ as shown in FIG. 11.

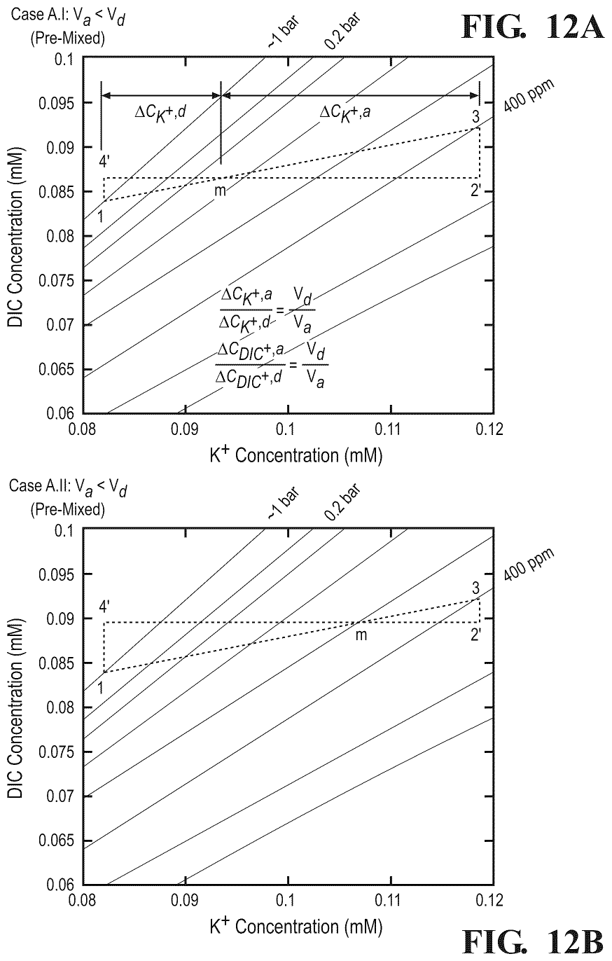

Additional variations on the present CO₂ capture process are also conceivable. For example, asynchronous or synchronous pre-mixed cycles may be adopted that respectively use either different electrolyte volumes or volumetric flow rates for alkalizing and dealkalizing reservoirs/streams. Particularly, FIG. 12A illustrates a cycle for the volume of electrolyte on the alkalizing/capture side (Vₐ) being greater than the volume of electrolyte on the dealkalizing/release side (V_{d}) and FIG. 12B illustrates a cycle for the volume of electrolyte on the alkalizing/capture side (Vₐ) being less than the volume of electrolyte on the dealkalizing/release side (V_{d}). Accordingly, the DIC swings achieved by alkalizing and dealkalizing streams can be adjusted independently to optimize energy consumption, process productivity, or any combination thereof.

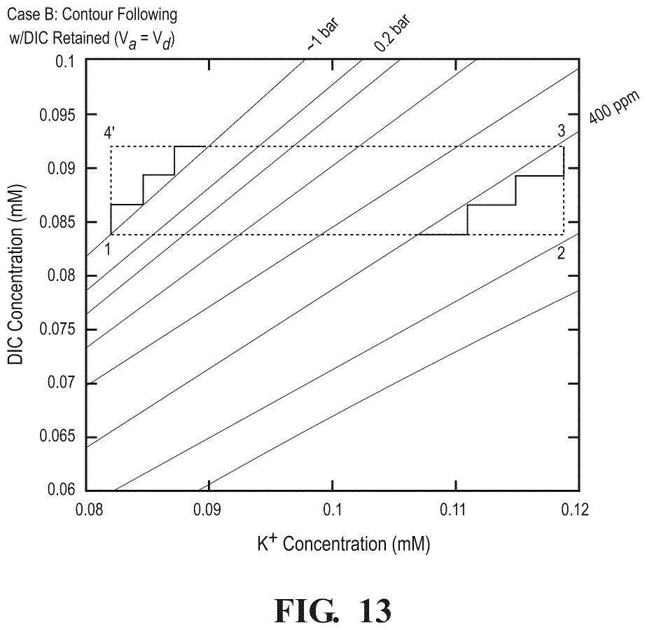

In the alternative, or in addition to, FIG. 13 illustrates asynchronous or synchronous DIC-retained cycles using “isobar stepping” to follow the pressure contours of interest for capture and release. In the limit of infinitesimal isobar stepping, thermodynamic energy consumption is minimized in theory because the states followed on the cycle diagram approach thermodynamic equilibrium, thus minimizing entropy generation. Different numbers of steps may be used for capture and release, and steps of different size may be used as needed.

The cycles discussed above may be augmented by performing steps between any two states at different temperatures. In so doing, heat may be used to promote CO₂ release or CO₂ capture, or heat may be used to decrease electrical energy input for alkalization and dealkalization.

In some variations, electrochemically inactive species with affinity toward protons (e.g., citric or acetic acid) or with affinity toward (bi)carbonate species (guanidinium cations) may be used to augment CO₂ isobars and thus moderate the cycle of interest. The present cycles can be implemented using: (a) symmetric soluble proton-coupled electron-transfer (PCET) cells that are separated by a CEM; (b) electrodialysis stacks using bi-polar membranes alternated with CEMs (also known as bi-polar membrane electrodialysis (BPMED)); and/or (c) capacitive electrodes in combination with various ion-exchange or bi-polar membranes.

In variations where the cycles are implemented via BPMED, a reversible, current-driven proton or hydroxide source or sink could be a bipolar membrane, rather than a proton-intercalation electrode. Also, and when an alkali-cation intercalation electrode is paired with a proton-intercalation electrode, the architecture of the electrolytic cell can eliminate the use of ion-exchange membranes. Also, Na₂TiV(PO₄)₃ electrodes intercalate Na⁺ from alkaline solutions, i.e., Na₂TiV(PO₄)₃ electrodes do not intercalate protons when Na⁺ cations are present in the electrolyte. And the same scenario occurs for Na₂TiV(PO₄)₃ electrodes cycled in the presence of Li⁺, i.e., Na₂TiV(PO₄)₃ electrodes intercalates Li⁺ instead of H⁺.

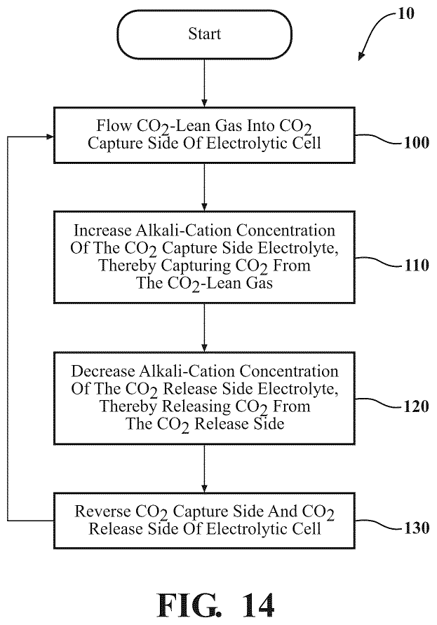

Referring now to FIG. 14, and with reference to FIG. 3A, a flow chart for a method 10 for direct capture of CO₂ from a CO₂-lean gas according to one form of the present disclosure is shown. The method 10 includes flowing CO₂-lean gas into a CO₂ capture side of the electrolytic cell shown in FIG. 3A at 100 and increasing the alkali-cation concentration of the CO₂ capture side electrolyte at 110. As discussed above, increasing the alkali-cation concentration of the CO₂ capture side electrolyte results in capturing CO₂ from the CO₂-lean gas flowing therethrough. The method 10 also includes decreasing the alkali-cation concentration of the CO₂ release side electrolyte at 120. And as discussed above, decreasing the alkali-cation concentration of the CO₂ release side electrolyte results in releasing CO₂ from the CO₂ release side electrolyte. At 130, the CO₂ capture side and the CO₂ release side of the electrolytic cell are reversed and the method 10 returns to 100 where flowing CO₂-lean gas into a CO₂ capture side of the electrolytic cell occurs. This cycle, i.e., 100, 110, 120, 130, 100, continues until a desired number of cycles have been completed.

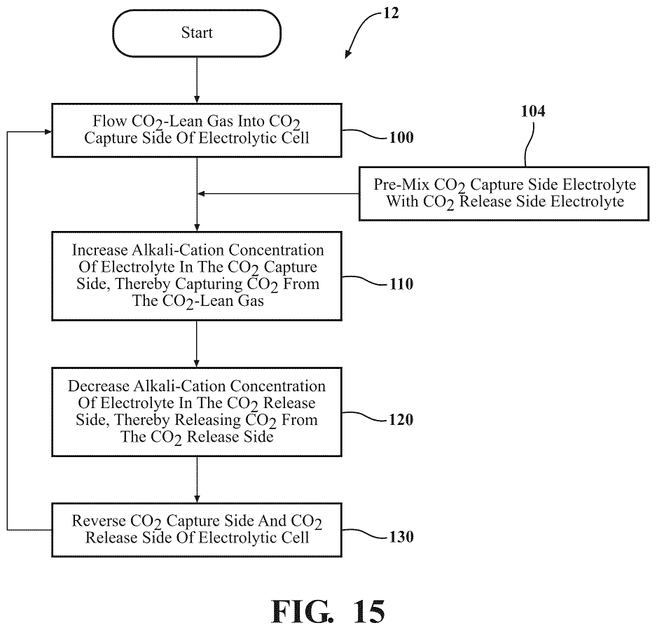

Referring to FIG. 15, a flow chart for a method 12 for direct capture of CO₂ from a CO₂-lean gas according to another form of the present disclosure is shown. The method 12 is generally the same as the method 10 except that pre-mixing of the CO₂ capture side electrolyte and the CO₂ release side electrolyte is performed at 104 as described above.

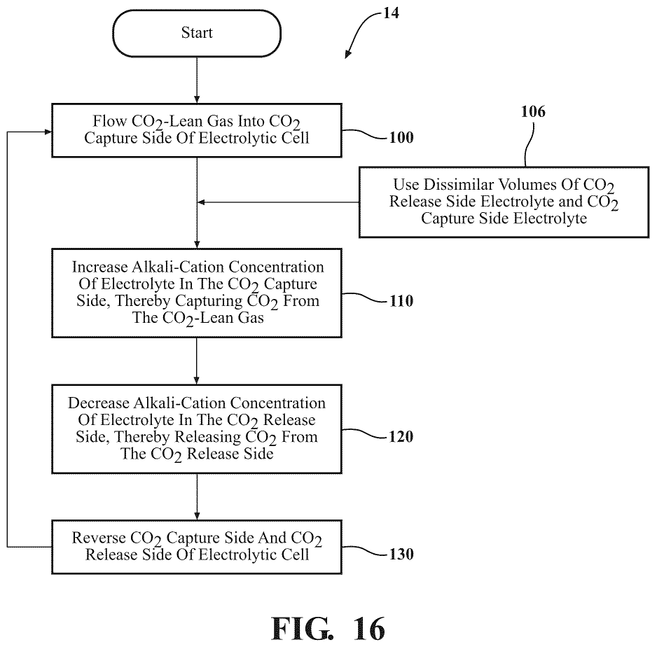

Referring to FIG. 16, a flow chart for a method 14 for direct capture of CO₂ from a CO₂-lean gas according to yet another form of the present disclosure is shown. The method 14 is generally the same as the method 10 except that dissimilar volumes of the CO₂ capture side electrolyte and the CO₂ release side electrolyte are used for the cycle 110, 120, 130, at 106 as described above.

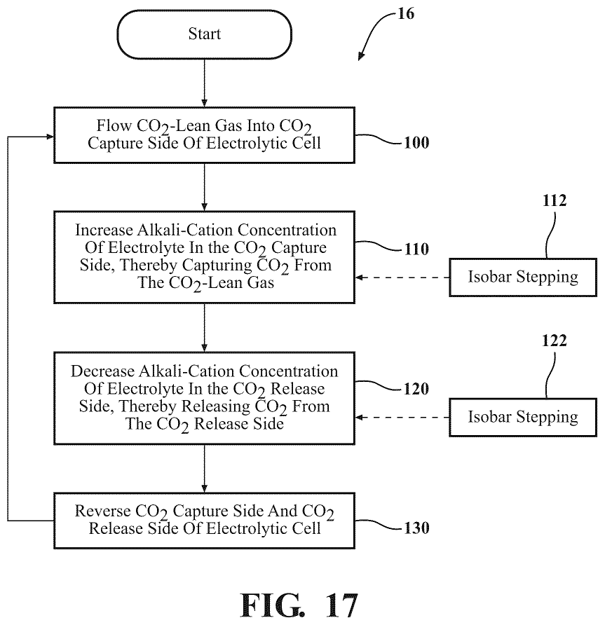

Referring to FIG. 17, a flow chart for a method 16 for direct capture of CO₂ from a CO₂-lean gas according to still another form of the present disclosure is shown. The method 16 is generally the same as the method 10 except that isobar stepping during the increasing the alkali-cation concentration of the CO₂ capture side electrolyte at 110 is performed at 112 and/or isobar stepping during the decreasing the alkali-cation concentration of the CO₂ release side electrolyte at 130 is performed at 122, as described above.

While FIGS. 14-17 illustrate CO₂ capture and release are integrated within an electrolytic cell, it should be understood that the teachings of the present disclosure provide for CO₂ capture and release using downstream gas/liquid mass transfer components.

While described as methods and illustrated with flowcharts, it should be understood that the present disclosure provides for systems that execute the methods described herein. For example, a system disclosed herein can include a processor, a memory communicably coupled to the processor and storing machine-readable instructions that, when executed by the processor, cause the processor to perform the methods and/or method steps disclosed herein, among others.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation, or particular system is included in at least one variation or form. The appearances of the phrase “in one variation” (or variations thereof) are not necessarily referring to the same variation or form. It should also be understood that the various method steps discussed herein do not have to be carried out in the same order as depicted, and not each method step is required in each variation or form.

As used herein, the term “about” when used in reference to a numerical value refers to values that are within +/−10% of the numerical value.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A method for capturing CO₂, the method comprising:
flowing a CO₂-lean gas into a CO₂ capture side of an electrolytic cell comprising the CO₂ capture side, a CO₂ release side, an electrolyte comprising a CO₂ capture side electrolyte and a CO₂ release side electrolyte, at least one reversible, current-driven proton or hydroxide source or sink (source/sink), and at least one reversible, current-driven alkali-cation source/sink; and
executing a cycle comprising:
capturing CO₂ from the CO₂-lean gas via increasing an alkali-cation concentration of the CO₂ capture side electrolyte;
releasing CO₂ from the electrolyte via decreasing an alkali-cation concentration of the CO₂ release side electrolyte such that a CO₂-rich gas is released therefrom; and
at least one step selected from one or more of isobar stepping during capturing the CO₂, isobar stepping during releasing the CO₂, pre-mixing the CO₂ capture side electrolyte with the CO₂ release side electrolyte, and using dissimilar volumes of the CO₂ capture side electrolyte and the CO₂ release side electrolyte.

2. The method according to claim 1, wherein the CO₂-lean gas is air with about 400 ppm CO₂.

3. The method according to claim 1, wherein the at least one reversible, current-driven proton or hydroxide source/sink is a pair of solid proton-intercalation electrodes selected from a pair of α-K_{0.05}MnO₂ electrodes, a pair of Co-substituted Ni(OH)₂ electrodes, a pair of Na₂TiV(PO₄)₃ electrodes, or a pair of LaNi₄Al electrodes.

4. The method according to claim 1, wherein the at least one reversible, current-driven alkali-cation source/sink is selected from a cation-exchange membrane or a pair of Na₂TiV(PO₄)₃ electrodes.

5. The method according to claim 1, wherein the electrolyte is selected from the group consisting of a lithium-based electrolyte, a sodium-based electrolyte, a rubidium-based electrolyte, a cesium-based electrolyte, and a francium-based electrolyte, and combinations thereof.

6. The method according to claim 1, wherein the at least one step is isobar stepping during capturing the CO₂.

7. The method according to claim 1, wherein the at least one step is isobar stepping during releasing the CO₂.

8. The method according to claim 1, wherein the at least one step is isobar stepping during capturing the CO₂ and isobar stepping during releasing the CO₂.

9. The method according to claim 1, wherein the at least one step is pre-mixing the CO₂ capture side electrolyte with the CO₂ release side electrolyte.

10. The method according to claim 1, wherein the at least one step is using dissimilar volumes of the CO₂ capture side electrolyte and the CO₂ release side electrolyte.

11. The method according to claim 1, wherein the a reversible, current-driven alkali-cation source or sink is a cation-exchange membrane.

12. The method according to claim 1, wherein the electrolyte is an alkaline electrolyte, the at least one reversible, current-driven proton or hydroxide source/sink is a pair of α-K_{0.05}MnO₂ electrodes, and the reversible, current-driven alkali-cation source/sink is a cation-exchange membrane.

13. The method according to claim 1, wherein the cycle has an efficiency Λ_{CO2} defined by:
$${Λ}_{CO 2} = Δ {c}_{DIC} / Δ {c}_{t o t , K +}$$
where Δc_{DIC} is the difference in dissolved inorganic carbon between the CO₂ capture side and CO₂ release side, Δ_{ctot,K+} is the swing of the alkali-cation concentration between the CO₂ capture side and CO₂ release side, and Λ_{CO2}>0.

14. A method for capturing CO₂, the method comprising:
flowing a CO₂-lean gas into a CO₂ capture side of an electrolytic cell comprising the CO₂ capture side, a CO₂ release side, an alkaline electrolyte comprising a CO₂ capture side electrolyte and a CO₂ release side electrolyte, at least one reversible solid proton-intercalation electrode, and a cation-exchange membrane; and
executing a cycle comprising:
capturing CO₂ from the CO₂-lean gas via increasing an alkali-cation concentration of the CO₂ capture side electrolyte;
releasing CO₂ from the electrolyte via decreasing an alkali-cation concentration of the CO₂ release side electrolyte such that a CO₂-rich gas is released therefrom; and
isobar stepping during capturing the CO₂ and isobar stepping during releasing the CO₂.

15. The method according to claim 14, wherein the CO₂-lean gas is air with about 400 ppm CO₂.

16. The method according to claim 14, wherein the at least one reversible solid proton-intercalation electrode is a pair of α-K_{0.05}MnO₂ electrodes.

17. The method according to claim 14, wherein the cycle has an efficiency Λ_{CO2} defined by:
$${Λ}_{CO 2} = Δ {c}_{DIC} / Δ {c}_{t o t , K +}$$
where Δc_{DIC} is the difference in dissolved inorganic carbon between the CO₂ capture side and CO₂ release side, Δ_{ctot,K+} is the swing of the alkali-cation concentration between the CO₂ capture side and CO₂ release side, and Λ_{CO2}>0.

18. A method for capturing CO₂, the method comprising:
flowing a CO₂-lean gas into a CO₂ capture side of an electrolytic cell comprising the CO₂ capture side, a CO₂ release side, an alkaline electrolyte comprising a CO₂ capture side electrolyte and a CO₂ release side electrolyte, at least one α-K_{0.05}MnO₂ electrodes, and a cation-exchange membrane; and
executing a cycle comprising:
capturing CO₂ from the CO₂-lean gas via increasing an alkali-cation concentration of the CO₂ capture side electrolyte;
releasing CO₂ from the electrolyte via decreasing an alkali-cation concentration of the CO₂ release side electrolyte such that a CO₂-rich gas is released therefrom; and
pre-mixing the CO₂ capture side electrolyte with the CO₂ release side electrolyte.

19. The method according to claim 18, wherein the CO₂-lean gas is air with about 400 ppm CO₂ and the at least one α-K_{0.05}MnO₂ electrode is a pair of α-K_{0.05}MnO₂ electrodes.

20. The method according to claim 18, wherein the cycle has an efficiency Λ_{CO2} defined by:
$${Λ}_{CO 2} = Δ {c}_{DIC} / Δ {c}_{t o t , K +}$$
where Δc_{DIC} is the difference in dissolved inorganic carbon between the CO₂ capture side and CO₂ release side, Δ_{ctot,K+} is the swing of the alkali-cation concentration between the CO₂ capture side and CO₂ release side, and Λ_{CO2}>0.
